(19) United States
(12) Patent Application Publication
(10) Pub. No.: US 2008/0263036 A1
(43) Pub. Date: Oct. 23, 2008

(54) DOCUMENT SEARCH APPARATUS, DOCUMENT SEARCH METHOD, PROGRAM, AND STORAGE MEDIUM

(75) Inventor: Masahito Yamamoto, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/854,250

(22) Filed: Sep. 12, 2007

(30) Foreign Application Priority Data
Dec. 13, 2006 (JP) 2006-336377

(51) Int. Cl. G06F 7/02

(52) U.S. Cl. 707/6

(57) ABSTRACT

An apparatus is configured to search for a document including a plurality of image components. The apparatus designates a key image to be used as a search key for an image search, sets a pattern of appearance in a document of the image component equivalent to the designated key image as a search condition, and searches for a document using the set search condition.

### BACKGROUND OF THE INVENTION

1. Field of the Invention

The present invention relates to an apparatus operable to perform document searches and a method therefor, and more specifically, to an apparatus capable of searching for documents containing images.

2. Description of the Related Art

In recent years, a data storage method has advanced and the manufacturing cost of a storage device has been reduced. Thus, a large amount of document data can be easily stored and managed. Furthermore, a file server and a document management system having advanced functions and a high performance have been widely used, and groupware for such a server apparatus and a system has been popularized.

As an information processing apparatus having advanced functions and a high performance has been developed, various image processing apparatuses, such as a copying machine, a printer, an image scanner, a facsimile apparatus, a digital camera, and a multifunction peripheral (MFP) having a function for storing a document and sending and receiving an image, can communicate with each other on a network.

Under a network-connected environment, a large amount of document data is always sent and received between various information processing apparatuses and image forming apparatuses. In this regard, a storage infrastructure for positively storing a traffic of documents flowing through a network in an office has been put into practice.

Japanese Patent No. 3486452 (U.S. Pat. No. 6,061,150) discusses a composite image forming apparatus to which at least two image data output apparatuses can be connected and that enables reliably storing a duplicate of an image without requiring an operator to perform a particular operation.

In order to effectively search for a desired document from among a vast amount of stored documents, it maybe important to provide a capability to search for documents that primarily includes images, in addition to searching text documents. A full text search may not be suitable for searching for a document that primarily includes an image instead of a text, such as a presentation material and a document having a large number of graphics and images. When a document including an image is searched with a search key designated based on the image, a full text search if singly conducted, may not be so useful.

Conventional similar image search methods search for a similar image using an image as a search key. A conventional similar image search method extracts an object according to edges in an image to determine a shape of the image and uses a position, a color, and relative positions of a plurality of objects to determine whether an image is a similar image. Another conventional similar image search method extracts a combination of dominant colors and color patterns constituting the entire image in a histogram and uses the result to determine whether an image is a similar image.

Japanese Patent Application Laid-Open No. 2006-065866 (U.S. Patent Application Publication No. 2006/0050985 A1) discusses a similar image search method using arithmetic processing for calculating a feature amount, which resembles recognitive similarity determination processing.

A document search using an image search method is not intended to search for an image designated as a search key itself but is intended to appropriately find a desired document including an image designated as a search key from among documents including a plurality of images.

For example, Japanese Patent Application Laid-Open No. 2002-149659 discusses a book search service method in which a user submits search request data including partial data of a book (e.g., a duplicate of one page of the book), a book database is searched using the submitted data, and a result of the search is notified to the requesting user.

In the method discussed by Japanese Patent Application Laid-Open No. 2006-065866 (U.S. Patent Application Publication No. US 2006/0050985 A1), which simply uses an image search method, it is rare that only one document is found as a search result. In most cases, a search result list includes a large number of documents, in which a large amount of “noises” (documents other than desired documents) are included.

This is because in a large-scale storage infrastructure, in most actual cases, a plurality of documents exist that have been created by reusing or modifying the same image.

A degree of similarity between images is represented by an analog continuous quantity. Thus, different images have a similarity to some extent. Accordingly, a result of a document search performed according to an image search is obtained as a continuous hit ratio, instead of a discrete result obtained according to whether a document is completely hit.

Accordingly, it is important to set detailed search conditions so that only documents substantially similar to a desired document are hit by narrowing a search result list as precise as possible.

The method discussed by Japanese Patent Application Laid-Open No. 2002-149659 searches a document (book) from partial page image data, as in the above-described conventional method. However, Japanese Patent Application Laid-Open No. 2002-149659 neither discusses nor suggests a configuration for narrowing a search with a high accuracy by designating a condition as to patterns that the page image data includes in a document.

### SUMMARY OF THE INVENTION

An embodiment of the present invention is directed to a document search method for searching for a document according to an image, by setting a search condition based on an appearance pattern of a search key image in a document.

According to an aspect of the present invention, an embodiment is directed to an apparatus configured to search for a document including a plurality of image components. The apparatus includes a key image designation unit configured to designate a key image to be used as a search key for an image search, a pattern setting unit configured to set a pattern of appearance in a document of the image component equivalent to the key image designated by the key image designation unit as a search condition, and a document search unit configured to search for a document using the search condition set by the pattern setting unit.

According to another aspect of the present invention, an embodiment is directed to a method for searching for a document that including a plurality of image components. The method includes designating a key image to be used as a search key for an image search, setting a pattern of appearance in a document of the image component equivalent to the designated key image, as a search condition, and searching for a document using the set search condition.

According to another aspect of the present invention, a document can be searched for, in a document search according to an image search, by setting a search condition according to an appearance pattern of a search key image in a document.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principle of the invention.

FIG. 1 illustrates an exemplary system configuration of an image processing system according to a first exemplary embodiment of the present invention.

FIG. 2 illustrates an exemplary software configuration of a job archiving application operating on a server system according to the first exemplary embodiment of the present invention.

FIG. 3 illustrates an exemplary hardware configuration of an image processing apparatus according to the first exemplary embodiment of the present invention.

FIG. 4 illustrates an example of an external appearance of the image processing apparatus according to the first exemplary embodiment of the present invention.

FIG. 5 illustrates an exemplary configuration of an operation unit of the image processing apparatus according to the first exemplary embodiment of the present invention.

FIG. 6 illustrates an exemplary inner configuration of the operation unit and an operation unit interface (I/F) of the image processing apparatus, comparing the same with an inner configuration of a control unit of the image processing apparatus according to the first exemplary embodiment of the present invention.

FIG. 7 illustrates an example of an operation screen displayed on the operation unit of the image processing apparatus according to the first exemplary embodiment of the present invention.

FIG. 8 illustrates an exemplary data structure of each database stored in a database (DB) management system according to the first exemplary embodiment of the present invention.

FIG. 9 is a flow chart illustrating an exemplary flow of search processing according to the first exemplary embodiment of the present invention.

FIG. 10 illustrates an example of a document search screen, which is an initial screen of a document search application, according to the first exemplary embodiment of the present invention.

FIG. 11 illustrates an example of a document search result list screen of the document search application according to the first exemplary embodiment of the present invention.

FIG. 12 illustrates a display example of a document hit in the search according to the first exemplary embodiment of the present invention.

FIG. 13 illustrates a display example of a document in which a plurality of pages have been hit in the search according to the first exemplary embodiment of the present invention.

FIGS. 14A through 14D each illustrate an example of a screen for setting a search condition determined according to an appearance pattern of a search key image according to the first exemplary embodiment of the present invention.

FIGS. 15A through 15E each illustrate an example of a screen for setting a search condition determined according to an appearance pattern of a search key image according to a second exemplary embodiment of the present invention.

FIG. 16 illustrates an example of a screen for setting a search condition determined according to an appearance pattern of a search key image according to a third exemplary embodiment of the present invention.

FIG. 17 illustrates an example of a document constituted by a plurality of image area components according to a fourth exemplary embodiment of the present invention.

FIG. 18 illustrates an example of a screen for setting a search condition determined according to an appearance pattern of a search key image according to the fourth exemplary embodiment of the present invention.

### DETAILED DESCRIPTION OF THE EMBODIMENTS

Various exemplary embodiments, features, and aspects of the present invention will now herein be described in detail with reference to the drawings. It is to be noted that the relative arrangement of the components, the numerical expressions, and numerical values set forth in these embodiments are not intended to limit the scope of the present invention unless it is specifically stated otherwise.

### First Exemplary Embodiment

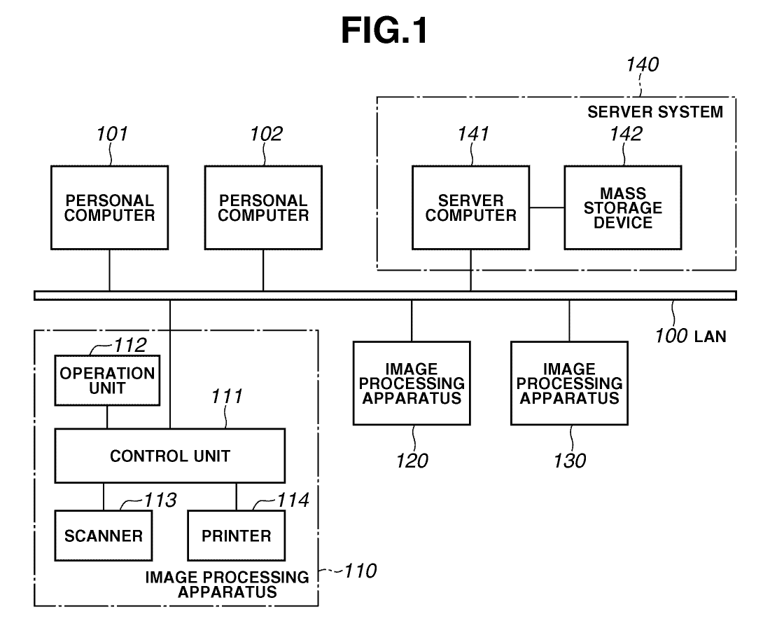

FIG. 1 illustrates an exemplary system configuration of an image processing system according to the present exemplary embodiment.

Referring to FIG. 1, the image processing system includes image processing apparatuses 110, 120, and 130, personal computers (PCs) (image processing apparatuses) 101 and 102, and a server system 140. In an embodiment, a local area network (LAN) 100 is used as a network.

The image processing apparatus 110 includes a scanner (image input device) 113, a printer (image output device) 114, a control unit 111, and an operation unit (user interface) 112.

The scanner 113, the printer 114, and the operation unit 112 are respectively connected to the control unit 111 and are controlled according to a command from the control unit 111. The control unit 111 is connected to the LAN 100.

The image processing apparatuses 120 and 130 have a configuration similar to that of the image processing apparatus 110.

The PC 101 is an information processing apparatus personally used by a plurality of users, and stores user data and an application program used by the user.

The server system 140 includes a server computer 141 and a large-scale storage device 142.

The server computer 141 stores a server application that provides a service to a plurality of users and client systems and also stores shared data. The large-scale storage device 142 is a highly reliable large-scale secondary storage device having a high performance. The large-scale storage device 142 primarily stores data for a database management system (DBMS) that mainly operates on the server computer 141.

One of server applications provided and serviced by the server system 140 is a database (DB) application for archiving (that is, storing and managing) job data flowing all over the LAN 100. The server application is hereinafter referred to as a “job archiving application”. The job archiving application cooperates with software installed on other apparatuses on the LAN 100 and constitutes a distributed application called a “job archiving system”.

In the system illustrated in FIG. 1, the PC 101 operates in cooperation with the image processing apparatuses 110, 120, and 130, and the server system 140 via the LAN 100. For example, the PC 101 sends and receives document data (hereinafter referred to as a “document”) between the image processing apparatus 110. The PC 101 performs jobs such as a print job, a scan job, a facsimile transmission job, a box (a document management system installed on the image processing apparatus 110) storage job, and a box retrieval job.

In performing a job for processing a document, the job archiving application operating on the server system 140 archives job information and a duplicate of document data which is to be processed in the job. For example, in the case of a print job, a printer driver of the PC 101 inputs a job into the image processing apparatus 110 and sends information related to the job and document data to be processed, to the server system 140. Thus, archiving of the job information and the document data to be processed in the job can be carried out.

In the system illustrated in FIG. 1, the image processing apparatus 110 operates in cooperation with the image processing apparatuses 120 and 130, the PCs 101 and 102, and the server system 140 via the LAN 100.

For example, the image processing apparatus 110 can send digitized image data obtained by scanning an image of a document to other apparatuses. In addition, the image processing apparatus 110 can perform a job for printing the data stored on other apparatuses by retrieving the data, storing the data into a local box, and transferring the data to other apparatuses.

In performing a document processing job, the job archiving application operating on the server system 140 archives the job information and the document data which is to be processed in the job.

For example, in the case of a push scan job, a “send” application on the image processing apparatus 110 sends digitized document data obtained by reading a document with a scanner, to a designated destination. Furthermore, the send application sends information related to the job (job information) and data to be processed in the job, also to the server system 140, to perform archiving.

As described above, job documents flowing all over the LAN 100 is archived by the job archiving application.

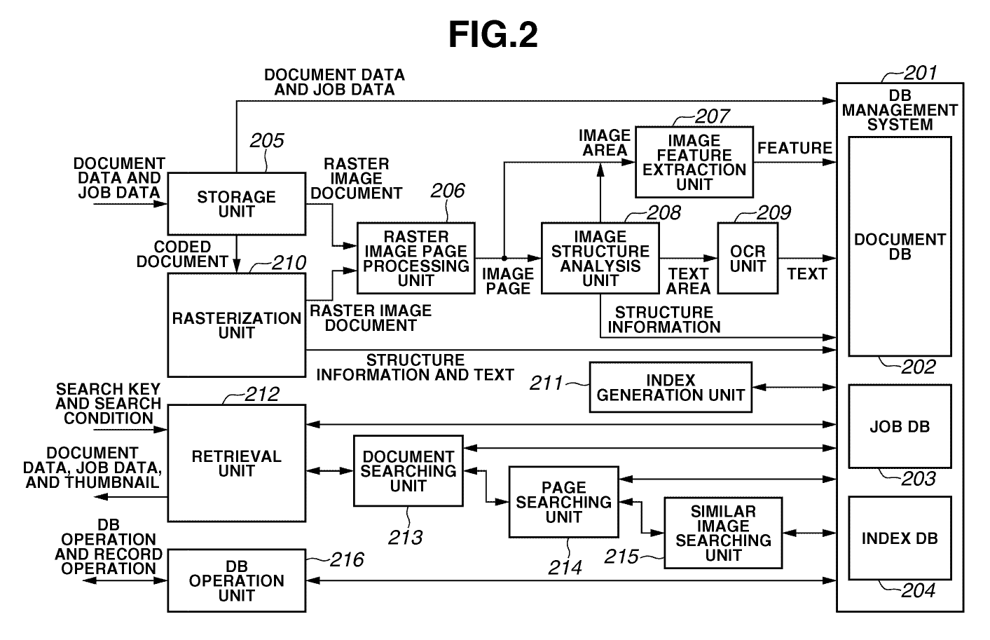

FIG. 2 illustrates an exemplary software configuration of the job archiving application operating on the server system 140 according to the present exemplary embodiment.

Referring to FIG. 2, a DB management system 201 stores a large amount of data including a large number of records as a structured database establishing an association between records. Furthermore, the DB management system 201 retrieves a record satisfying a designated condition from the database at a high speed according to a request issued in a query language such as a structured query language (SQL).

The DB management system 201 includes a document DB 202, a job DB 203, and an index DB 204. The DB management system 201 can be implemented using a suitable relational database or an object-oriented database.

The document DB 202 is a database that stores document data stored and managed by the job archiving system. The document DB 202 stores document content data and meta data related to the document as a document record. The document DB 202 and the job DB 203 are associated with each other, between the stored records.

The job DB 203 is a database that stores job data stored and managed by the job archiving system as a job record. The job DB 203 and the document DB 202 are associated with each other, between stored records.

The index DB 204 is a database that stores an index record for searching for desired data at a high speed from the document data and job data stored and managed by the job archiving system. The index record stored in the index DB 204 refers to the record in the document DB 202 and the job DB 203.

A storage unit 205 is a storing request receiving module that receives document data and job data from a client apparatus such as the image processing apparatus 110 and the PC 101 to store the received document data and job data in the DB management system 201.

The storage unit 205 stores received document data and job data in the DB management system 201, as described above. In addition, the storage unit 205 switches to processing for generating meta data according to a data format of the received document data.

In the case where the document data that the storage unit 205 receives is raster image document data generated by reading with an image scanner or shooting with a digital camera, or received by a facsimile apparatus, the storage unit 205 sends the received document data to a raster image page processing unit 206.

In the case where the document data that the storage unit 205 receives is coded document data, the storage unit 205 sends the data to a rasterization unit 210. For example, the storage unit 205 sends various documents described in a page description language (PDL) and various vector-expressed documents to the rasterization unit 210.

Furthermore, the storage unit 205 sends document data having a document format in various applications, such as a desktop publishing application, a word processor, a spreadsheet, a presentation application, a drawing application, or a painting application, to the rasterization unit 210.

The raster image page processing unit 206 is a module for processing a raster image document per image page by extracting and separating a page (image page) constituting a document. The raster image page processing unit 206 sends the separated image page to an image feature extraction unit 207 and an image structure analysis unit 208.

The image feature extraction unit 207 is a module for extracting feature data (hereinafter referred to as a “feature”) used as a reference for determining a similarity between images by analyzing raster image data. The extracted feature data is sent to the DB management system 201 to be stored therein.

Various methods for extracting a feature can be effectively used for searching a similar image search. In the present exemplary embodiment, a plurality of useful methods can be used, instead of depending on a specific algorithm. The following methods, for example, can be employed.

For example, a method can be used that uses a shape, a position, colors, and a positional relationship between a plurality of objects, by extracting an object according to edges in an image to determine the shape of the object. Further, a method can be used that extracts a combination and a pattern of dominant colors constituting the entire image in a histogram. Furthermore, a method can be used that performs various arithmetic processing (e.g., Fourier Mellin Transforms) for extracting a feature amount, which is similar to recognitive similarity determination processing. Moreover, the method discussed by Japanese Patent Application Laid-Open No. 2006-065866 (U.S. Patent Application Publication No. 2006/0050985 A1) can also be used.

The image structure analysis unit 208 is a module for analyzing a structure of raster image data.

More specifically, the image structure analysis unit 208, using a method such as a block selection or a block separation, breaks down a cluster of image areas (image page) into a plurality of constituent areas having a mutually different characteristic. For example, the image structure analysis unit 208 breaks down an image page into a plurality of areas (namely, a text area, an image area, a photograph area, a graphics area, a monochromatic area, and a color area, for example) and analyzes and classifies the areas with respect to a structure of each area.

Furthermore, the image structure analysis unit 208 performs an analysis and a classification related to a layer structure with respect to a background pattern and a text or the shape of objects arranged on the background. The image structure analysis unit 208 sends raster image data of an image area (or image layer) obtained as a result of the analysis to the image feature extraction unit 207. The image structure analysis unit 208 sends raster image data of a text area (or text layer) obtained as a result of the analysis to an optical character recognition (OCR) unit 209. Furthermore, the image structure analysis unit 208 sends structure information obtained as a result of the analysis to the DB management system 201 to store the structure information in the DB management system 201.

The OCR unit 209 is a module for analyzing and character-recognizing raster image data in which a text is rendered. The OCR unit 209 sends the character-recognized text data (i.e., data coded according to Unicode) to the DB management system 201 and stores the text data in the DB management system 201.

An index generation unit 211 is a module for generating index information for searching for data from the document DB 202 and the job DB 203 at a high speed.

The index generation unit 211 generates an index, previous to a search. An index is used for searching for a document record including an image similar to an image that is designated as a search key, at a high speed. In addition, an index is used for full-text-searching for a document record that includes a text designated as a search key in document content data or page content data, at a high speed. Furthermore, an index is used for searching for a document record or a job record having meta data satisfying a condition designated as a search key, at a high speed. A publicly known plurality of methods can be used for generating an index.

An “N-gram” method, for example, is used in generating an index for a full text search. In generating an index for a similar image search, feature vectors expressing a feature of an image are previously clustered or arranged in order according to a hash function.

The index generation processing by the index generation unit 211 is performed when the document DB 202 or the job DB 203 has been updated in performing an additional registration or editing document data or job data. An index can also be generated by batch processing asynchronous to the updating of the document DB 202 or the job DB 203. The generated index is stored in the index DB 204 of the DB management system 201.

A retrieval unit 212 is a module for acquiring a search key (a search key image or a search key text) and a search condition for a search from a client apparatus such as the image processing apparatus 110 or the PC 101.

The retrieval unit 212 retrieves document data from the DB management system 201 according to the received search condition. The retrieval unit 212 sends meta data such as hit document data, a thumbnail image (hereinafter referred to as a “thumbnail”) related to the document, and job data to a client apparatus.

A document searching unit 213 is a module for searching for a document that matches a document search request. The document searching unit 213 is capable of conducting a search based on document content data, page data included in a document, or meta data of a document, according to a search request and a type of a designated search key. Furthermore, the document searching unit 213 can search for a plurality of candidates of document records that match a search request, combining searches according to a job related to the document.

A page searching unit 214 searches the document DB 202 for a plurality of candidates of page records (and documents including the page) that match a condition designated by a search request, in response to a request for search based on page data included in a document.

A similar image searching unit 215 searches for a plurality of page records (and documents including the page) having page content data that includes an image similar to a search key image, according to a request for searching for a similar image based on an image designated as a search key. The similar image searching unit 215 performs an image feature extraction on a search key image, just like the image feature extraction unit 207, and searches for a similar image based on a similarity between features of a search target image and a search key image.

A DB operation unit 216 is a database operation module that receives from a client apparatus a request for performing an operation on a database or an operation on records in each database, performs the requested operation, and sends a result of the operation to the client apparatus. A management console of the server computer 141, the image processing apparatus 110, and the PC 101 can be used as the client apparatus. The operation on the record includes an operation for adding or editing meta data (tag).

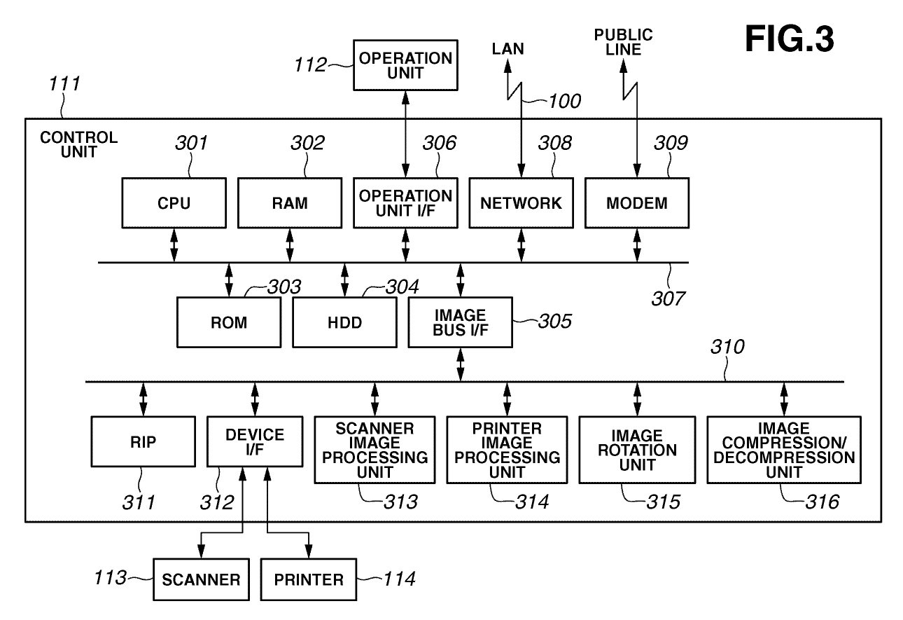

FIG. 3 illustrates an exemplary hardware configuration of the image processing apparatus 110 according to the present exemplary embodiment. The image processing apparatuses 120 and 130 have a configuration similar to that illustrated in FIG. 3.

Referring to FIG. 3, the control unit 111 is in communication with the scanner 113 and the printer 114 via the LAN 100 and a public line (wide area network (WAN)), and thus controls input and output of image information and device information.

A central processing unit (CPU) 301 controls the entire control unit 111. A random access memory (RAM) 302 serves as a system work memory for the CPU 301. The RAM 302 also serves as an image memory for temporarily storing image data. A read-only memory (ROM) 303 is a boot ROM and stores a boot program for the system. A hard disk drive (HDD) 304 stores system software and image data.

An operation unit I/F 306 is an interface between the image processing apparatus 110 and the operation unit (user interface (UI)) 112 and outputs to the operation unit 112 image data to be displayed on the operation unit 112. The operation unit I/F 306 sends information input by a user via the operation unit 112, to the CPU 301.

A network I/F 308 is an interface between the image processing apparatus 110 and the LAN 100. The modem 309 makes connection with a public line and serves as a communication unit for data communication between the image processing apparatus 110 and the public line. The above-described devices and units are in communication with one another via a system bus 307.

An image bus I/F 305 is an interface between the system bus 307 and an image bus 310, through which image data is transferred at a high speed. The image bus I/F 305 is a bus bridge for converting a data structure. A peripheral component interconnect (PCI) bus or Institute of Electrical and Electronic Engineers (IEEE) 1394 can be used as the image bus 310.

The following devices are connected to the image bus 310. A raster image processor (RIP) 311 rasterizes a PDL code sent via the network into a bitmap image. A device I/F 312 is an interface between the control unit 111 and input/output devices such as the scanner 113 and the printer 114. The device I/F 312 converts synchronous image data into asynchronous image data and vice versa.

A scanner image processing unit 313 performs various processing such as correction, processing, and editing on input image data. A printer image processing unit 314 performs processing such as image correction and resolution conversion on image data to be printed out, according to performance of the printer 114. An image rotation unit 315 rotates image data. An image compression/decompression unit 316 compresses and decompresses multivalued image data according to Joint Photographic Experts Group (JPEG) format. Further, the image compression/decompression unit 316 compresses and decompresses binary image data according to Joint Bi-level Image Experts Group (JBIG) format, Modified Modified Read (MMR) format, and Modified Huffman (MH) format.

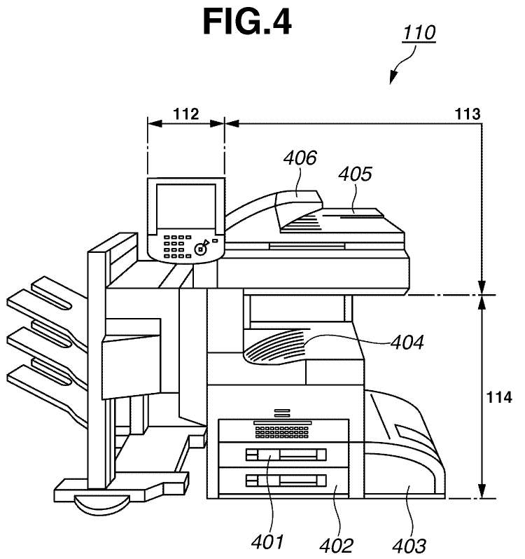

FIG. 4 illustrates an example of an external appearance of the image processing apparatus 110. The image processing apparatuses 120 and 130 have an external appearance similar to the image processing apparatus 110. Hereinbelow, as an example, the image processing apparatus 110 will be described. However, the image processing apparatuses 120 and 130 have a configuration similar to the image processing apparatus 110, and thus can perform an operation similar to the image processing apparatus 110.

The scanner 113, which is an image input device, illuminates an image on a recording medium (paper) (i.e., a document) and scans with a charge-coupled device (CCD) line sensor (not illustrated), to generate raster image data.

When a user places paper documents on a tray 406 of a document feeder 405 and operates the operation unit 112 to issue an instruction for starting reading of the documents, the CPU 301 of the control unit 111 sends the user instruction to the scanner 113. Then, the documents set on the tray 406 are fed sheet by sheet and the scanner 113 reads the fed document, according to the user instruction.

The printer 114, which is an image output device, prints out raster image data on a recording medium (paper). An electrophotographic printing method using a photosensitive drum and a photosensitive belt and an inkjet printing method for directly forming an image on a recording medium (paper) by ejecting ink from a fine nozzle array can be used as a method for printing. The print processing starts according to an instruction from the CPU 301.

The printer 114 includes a plurality of paper feed stages so that a user can select a paper size and orientation from a plurality of paper sizes and orientations. The printer 114 includes paper cassettes 401, 402, and 403, corresponding to different paper sizes and orientations. Printed products are discharged and stacked on a paper discharge tray 404.

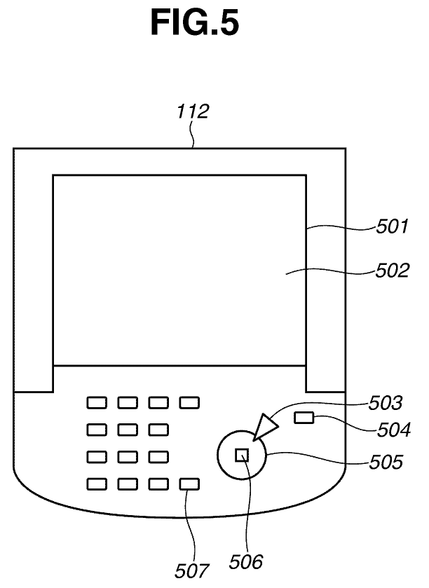

FIG. 5 is a top view illustrating a configuration of the operation unit 112 of the image processing apparatus 110 according to the present exemplary embodiment. The image processing apparatuses 120 and 130 have a configuration similar to the image processing apparatus 110.

A liquid crystal display (LCD) unit 501 includes a touch panel sheet provided on an LCD. The LCD display unit 501 displays an operation screen for the image processing apparatus 110 and soft keys. When a user presses a soft key displayed on the operation screen, the LCD display unit 501 sends positional information of the pressed portion to the CPU 301 of the control unit 111.

A start key 505 can be operated by a user to start an operation for reading an image of a document. In a center portion of the start key 505, light-emitting diodes (LEDs) display 506 of green and red are provided. The two colors of the LEDs 506 indicate whether the start key 505 is in an operable state or not.

A stop key 503 can be operated by a user to stop the current operation of the image processing apparatus 110. An identification (ID) key 507 can be operated by a user to enter a user ID. A reset key 504 can be operated by a user to initialize a setting set by the operation unit 112.

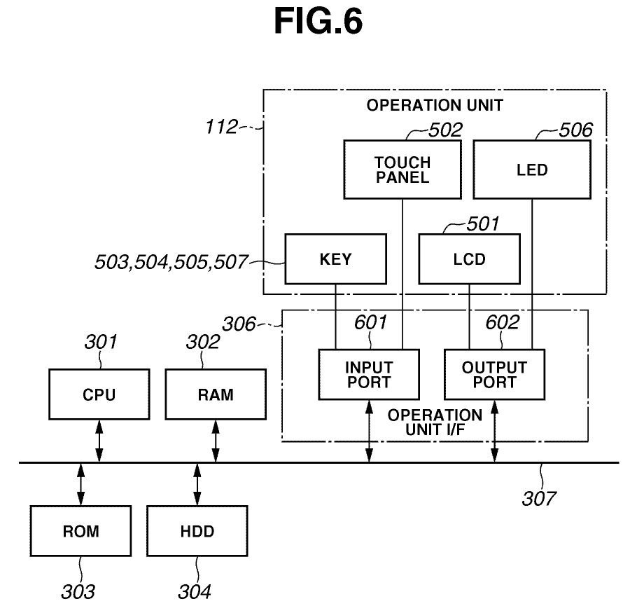

FIG. 6 illustrates an exemplary inner configuration of the operation unit 112 and the operation unit I/F 306 of the image processing apparatus 110, and compares the same with an inner configuration of the control unit 111 according to the present exemplary embodiment. Hereinbelow, as an example, the image processing apparatus 110 will be described. However, the image processing apparatuses 120 and 130 have a configuration similar to the image processing apparatus 110, and thus can perform an operation similar to that performed by the image processing apparatus 110.

As described above, the operation unit 112 is connected to the system bus 307 via the operation unit I/F 306. The CPU 301, the RAM 302, the ROM 303, and the HDD 304 are in communication with one another via the system bus 307.

The CPU 301 controls all accesses to and from various devices on the system bus 307 according to a control program stored on the ROM 303 and the HDD 304. The CPU 301 reads information input from the scanner 113 connected via the device I/F 312. Furthermore, the CPU 301 outputs an image signal as output information to the printer 114 connected via the device I/F 312. The RAM 302 serves as a main memory and a work area for the CPU 301.

Information input via the touch panel of the touch panel 502 and hard keys 503, 504, 505, and 507 is transferred to the CPU 301 via an input port 601. The CPU 301 generates data to be displayed on the operation screen according to the content of the user input information and the control program, and outputs the display screen data to the LCD display unit 501 via an output port 602 that controls a screen output device. Furthermore, the CPU 301 controls the two-color LED display unit 506 as necessary.

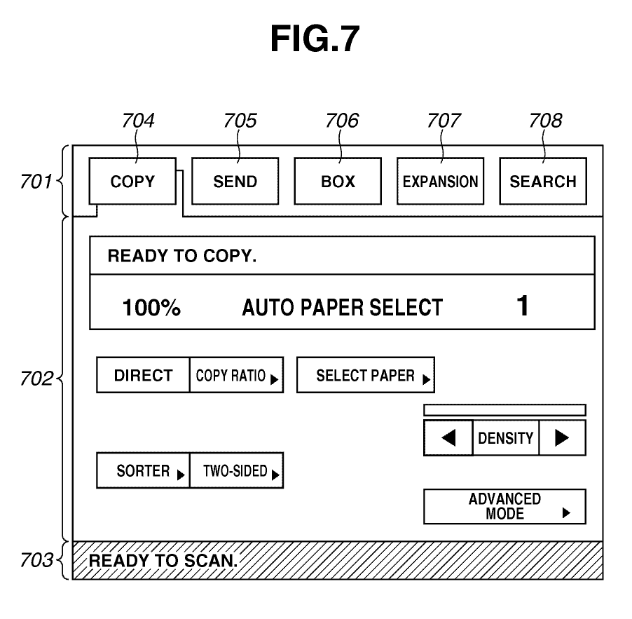

FIG. 7 illustrates a standard operation screen in an initial state displayed on the operation unit 112 of the image processing apparatus 110.

Buttons provided in a display field 701 in an upper portion of FIG. 7 can be operated by a user to select one function from various functions that the image processing apparatus 110 provides. A copy function 704 is a function for printing document image data scanned and read with the scanner 113, by the printer 114 to produce a copied product of the document.

A send function 705 is a function for sending document image data read with the scanner 113 or image data stored on the HDD 304 to various output destinations. The data can be sent to output destinations according to various kinds of protocols via the network I/F 308 and to output destinations according to a facsimile protocol via a modem 309 (FIG. 3). The send function 705 allows a user to select a plurality of output destinations and send the data thereto at the same time.

A box function 706 is a function for browsing, editing, printing, and editing a document file including image data and coded data stored on the HDD 304. A document file stored on the HDD 304 can include document image data read by the scanner 113 and data downloaded via the network I/F 308. Furthermore, the document file stored on the HDD 304 can include print data received from an external apparatus via the network I/F 308 and facsimile data received by a facsimile apparatus via the modem 309.

The box function 706 can be used as an e-mail box in an office environment of the user. In addition, by delaying printing out of the data on a print paper until the user enters his/her password, the box function 706 can be used as a secured printing function which enhances the confidentiality of a PDL print job.

With the box function 706, the image processing apparatus 110 can access an HDD of the image processing apparatuses 120 and 130 and a shared file system allowed to be shared in the PCs 101 and 102, and can thus browse, edit, print, and send the data. Furthermore, with the box function 706, the image processing apparatus 110 can access a shared file system of the server system 140 and a document file including image data and coded data stored on a database system, and can thus browse, edit, print, and send the data.

An expansion function 707 is a function for calling various expanded functions to utilize the scanner 113 from an external apparatus.

A search function 708 is a function for searching for a desired document from a box of the image processing apparatus 110 or a box of other image processing apparatuses. With the search function 708, the image processing apparatus 110 can search for a desired document from a file system shared in an image processing apparatus and a shared file system or a database system provided by the server system 140.

In a display field 702, which is illustrated in a middle portion of FIG. 7, an operation screen is displayed when the user selects the copy function 704. A status display field 703 in a lowermost portion of FIG. 7, displays a message relating to each function of the image processing apparatus 110 and various information about the image processing apparatus 110 to the user, regardless of the function selected via the uppermost display field 701.

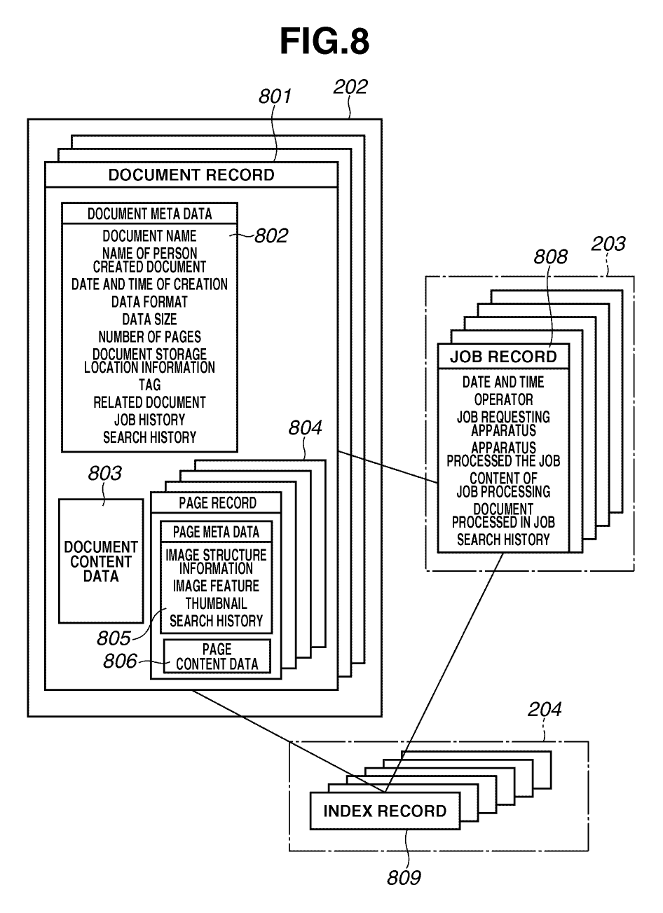

FIG. 8 illustrates an exemplary data structure of each database stored in the DB management system 201 according to the present exemplary embodiment.

The document DB 202 includes a plurality of document records 801. The document record 801 is a record corresponding to a paper document and an electronic document file handled by the user. The document record 801 includes document meta data 802, document content data 803, and a plurality of page records 804.

The document meta data 802 is a record for storing various kinds of meta data related to the document corresponding to the document record 801. The document meta data 802 includes information such as a document name, an author name, a date and time of creation, a data format, a data size, a number of pages, a tag, and a job history, which are related to the corresponding document.

A “tag” is information similar to a keyword constituted by an arbitrary text string provided by the user to the document. A document search can be performed according to a tag.

A user can arbitrarily provide a plurality of tags to one document. Accordingly, documents can be classified based on various reference conditions and easily searched by the tags provided to documents. A plurality of users can later add a tag to a shared document in order to refer to and utilize the document. Thus, highly useful meta data for classifying and searching for a document can be obtained.

This method is sometimes referred to as “folksonomy”, which is derived from words “folks” (i.e., everyone) and “taxonomy” (i.e., classification method).

The job history is a list of reference information for identifying a series of jobs performed to a document as a processing target. One document record can hold reference information to a plurality of job records. For example, if a document, which is clearly identified as the same document, is processed in a plurality of jobs, one document record holds reference information referring to a plurality of jobs.

The document content data 803 corresponds to a content of a document itself. A text and data for an application program stored in a coded form are the document content data 803. In the case of raster image data obtained by reading a paper document with the scanner 113, in which pages constituting a document are apparently separated from one another, the content data is included in the page record 804.

The page record 804 corresponds to each of the pages constituting a document. A plurality of raster image data obtained by reading with the scanner 113, image data obtained by rasterizing the application program data in the rasterization unit 210 and divided page by page, structure information, text data, and a plurality of meta data, correspond to each page record 804.

The page record 804 includes the page meta data 805 and the page content data 806. The page meta data 805 stores various kinds of meta data related to a page corresponding to the page record 804. The page meta data 805 includes structure information, a feature, and a thumbnail.

The structure information is related to a structure of the page analyzed and stored by the image structure analysis unit 208 and the rasterization unit 210. The feature is information expressing a feature of an image constituting a page extracted by the image feature extraction unit 207 and stored. A thumbnail is an image obtained by resolution-converting (or reducing) the entire page or an image component included in the page and thus making it into a small size image that can be relatively easily handled.

A thumbnail image can be generated at the time of generation of the page record 805 or can be generated on-demand if required to respond to an external retrieval operation. Furthermore, a thumbnail image can be generated at once in scheduled batch processing by asynchronously performing a task for generating thumbnail images which are yet to be generated.

The page content data 806 corresponds to a content of a page itself. The page content data 806 stores raster image data obtained by reading a page of a paper document with an image scanner and a page-by-page image data obtained by rendering a coded document into a page with the rasterization unit 210. The page content data 806 can also store text data obtained by character-recognizing a page image with the OCR unit 209 and page-by-page text information obtained by rasterizing a coded document with the rasterization unit 210.

The job DB 203 includes a plurality of job records 808. The job record 808 corresponds to each of document processing jobs instructed by a user. The job record 808 includes a “job date and time”, a “job operator”, a “job requesting apparatus”, a “job processing apparatus”, a processed content”, and a “processed document”. The date and time expresses a date and time on which the job was performed. A job operator identifies the user who carried out the job.

The job requesting apparatus is a source apparatus requesting the job. For example, in the case where a user has issued an instruction for printing data via the PC 101 and the image processing apparatus 110 has printed out the data, the PC 101 is the job requesting apparatus.

The “job processing apparatus” is an apparatus that have actually performed the job. For example, in the case where data is sent from the PC 101 and printed out by the image processing apparatus 110, the image processing apparatus 110 is the job processing apparatus.

The job processing content is information for identifying a content of the processed job. The job processing content includes information for identifying a job type, how various options selectable in each job type and various parameters that can be set, were selected, set and processed.

The processed document describes a list of reference information for identifying the document processed in the job. One job record can refer to a plurality of document records, for example, in the case where one job has been performed on a plurality of documents.

The index DB 204 includes a plurality of the index records 809. The index record 809 is index information for searching for a data from the document DB 202 and the job DB 203 at a high speed. The index record 809 refers to a plurality of the document records 801 and a plurality of the job records 808.

The index record 809 is generated by the index generation unit 211. The index record 809 can be used for searching for a document record including an image similar to a search key image at a high speed.

Furthermore, the index record 809 can be used for full-text-searching of a document record including a search key text in its document content data or page content data at a high speed.

In addition, the index record 809 can be used for searching a document record or a job record having meta data matching a search key condition at a high speed.

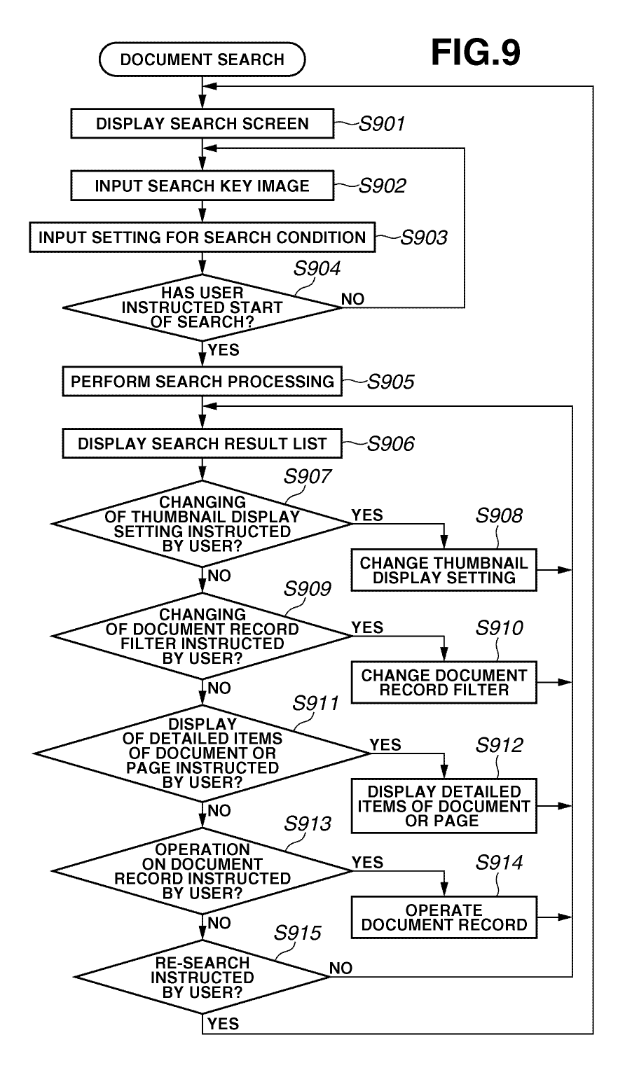

FIG. 9 is a flow chart illustrating a flow of search process according to the present exemplary embodiment. The search process according to an exemplary embodiment is implemented by a built-in application program executed by the CPU 301 of the image processing apparatus 110. The built-in application is hereinafter referred to as a “document search application”.

A series of processing in the flow chart of FIG. 9 starts when a user presses a “search” button in the display field 701 of the operation unit 112.

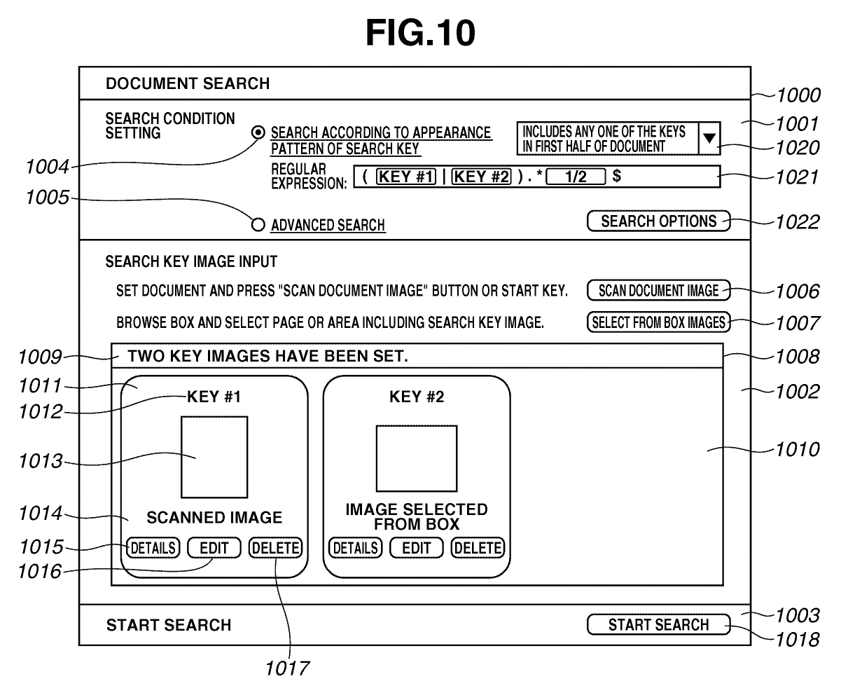

Referring to FIG. 9, in step S901, an initial screen is displayed for the document search function (search screen) on the display field 702 of the operation unit 112. By interacting with the search screen, the user can issue an instruction for setting a search condition, enter a search key, and issue an instruction for starting a search via the search screen. A configuration of the search screen will be described below with reference to FIG. 10.

In step S902, a search key image is input according to the user instruction. Additionally, in step S903, other search condition settings are input according to the user instruction.

In step S904, the process waits until the user inputs an instruction for starting a search. If it is determined in step S904 that the user has not issued an instruction for starting a search (NO in step S904), then the process returns to step S902 to repeat the user input of search key images and other search condition settings. On the other hand, if it is determined in step S904 that the user has issued an instruction for starting a search (YES in step S904), then the process advances to step S905.

In step S905, search processing is started. At this time, the document search application accesses the job archiving application operating on the server system 140 and sends the search key and the search condition to the retrieval unit 212.

The process receives data necessary for displaying a search result list with respect to one or more documents that match (that hit) the search condition as a result of the retrieval by the retrieval unit 212. In most cases, a large number of documents may hit the search, according to the characteristics of a similar image search and a full text search.

The data necessary for displaying the search result list is the meta data included in the document record corresponding to the hit document or a part of the data included in the job record associated with the document record.

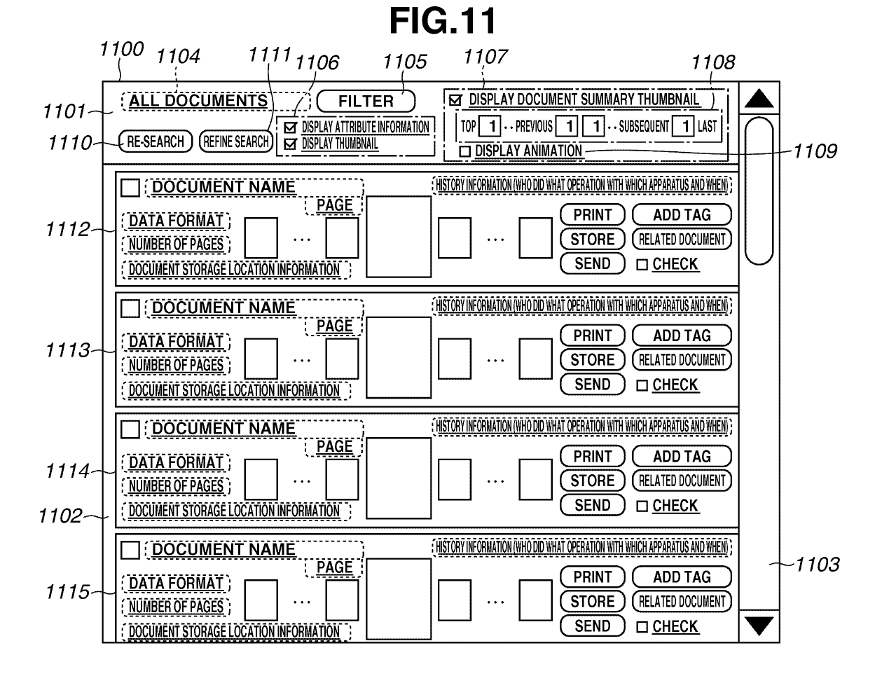

In step S906, the search result list is displayed according to the information received from the job archiving application. A configuration for displaying a search result list will be described below with reference to FIG. 11.

In step S907, it is determined whether the user has issued an instruction for changing a setting for displaying a thumbnail. If it is determined in step S907 that the user has issued an instruction for changing a setting for displaying a thumbnail (YES in step S907), then the process advances to step S908. In step S908, the setting for displaying a thumbnail is changed. Then, the process returns to step S906. In step S906, the process displays the search result list again according to the changed thumbnail display setting.

On the other hand, if it is determined in step S907 that the user has not issued an instruction for changing a setting for displaying a thumbnail (NO in step S907), then the process advances to step S909.

In step S909, it is determined whether the user has issued an instruction for changing a document record filter. If it is determined in step S909 that the user has issued an instruction for changing a document record filter (YES in step S909), then process advances to step S910. In step S910, the document record filter is changed. Then, the process returns to step S906. In step S906, the search result list is displayed again according to the changed document record filter.

On the other hand, if it is determined in step S909 that the user has not issued an instruction for changing a document record filter (NO in step S909), then the process advances to step S911.

In step S911, it is determined whether the user has issued an instruction for displaying a detailed item for the document or the page. If it is determined in step S911 that the user has issued an instruction for displaying a detailed item for the document or the page (YES in step S911), then the process advances to step S912. In step S912, a window displaying the selected document and detailed information for the job is displayed. When the user closes the detailed item display window, the process returns to step S906 to display the search result list again.

On the other hand, if it is determined in step S911 that the user has not issued an instruction for displaying a detailed item for the document or the page (NO in step S911), then the process advances to step S913.

In step S913, the process determines whether the user has instructed an operation on the document record. The operation that can be performed on the listed document record(s) includes printing, storing, sending, adding a tag, displaying a related document search, and marking.

If it is determined in step S913 that the user has instructed an operation on the document record (YES in step S913), then the process advances to step S914. In step S914, an operation is performed on the document record corresponding to the user instruction. Then, the process returns to step S906 to display the search result list again.

On the other hand, if it is determined in step S913 that the user has not instructed an operation on the document record (NO in step S913), then the process advances to step S915.

In step S915, it is determined whether the user has issued an instruction for performing a re-search. If it is determined in step S915 that the user has not issued an instruction for performing a re-search (NO in step S915), then the process returns to step S906 to display the search result list again. On the other hand, if it is determined in step S915 that the user has issued an instruction for performing a re-search (YES in step S915), then the process returns to step S901 to perform the series of search processing again.

The series of processing can also be performed by the PC 101. Alternatively, the series of operations can be divided into partial portions, and software for performing each processing can be installed on a plurality of different apparatuses to perform the processing in a distributed manner. The software used in this case serves as a distributed application.

For example, the image processing apparatus 110 can display the search screen and the search result list and input the user instruction. The PC 101, the server system 140, and the image processing apparatuses 120 and 130 can perform other processing.

Alternatively, the PC 101 can perform the display of the search screen and the search result list and input the user instruction, and the image processing apparatus 110 and the server system 140 can perform other processing.

In the case where the user operates the document search application via the PC 101, the operation for entering an image onto a paper document as a search key image can be less convenient than in the case where the user operates the image processing apparatus 110 with the scanner 113 on hand.

In this case, images stored by the box function of the image processing apparatus 110 can be operated via the PC 101 or the image processing apparatuses 120 and 130. Accordingly, the user can easily input and use the image selected from the box, as a search key image.

The distributed application can also be implemented by a web application, which can be implemented by a combined use of a web browser and a web server.

FIG. 10 illustrates an example of a configuration of the document search screen, which is an initial screen of the document search application according to the present exemplary embodiment.

Referring to FIG. 10, a document search screen 1000 is an initial screen for the document search application. The document search application according to the present exemplary embodiment displays the document search screen on the display field 702 of the operation unit 112. The document search screen 1000 includes a search condition setting field 1001, a search key image input field 1002, and a search start instruction field 1003.

Via the search condition setting field 1001, the user can set and verify a search condition. A “search according to appearance pattern of search key” radio button 1004 can be operated by the user to select a basic search condition and verify a selected condition. When the “search according to appearance pattern of search key” radio button 1004 is selected, the CPU 301 performs the search according to a pattern of appearance of the search key in the document.

A search key appearance pattern pull down menu 1020 can be operated when the “search according to appearance pattern of search key” radio button 1004 is selected. The search key appearance pattern pull down menu 1020 can be operated by the user to select a pattern of appearance of the search key in the document, as the search condition.

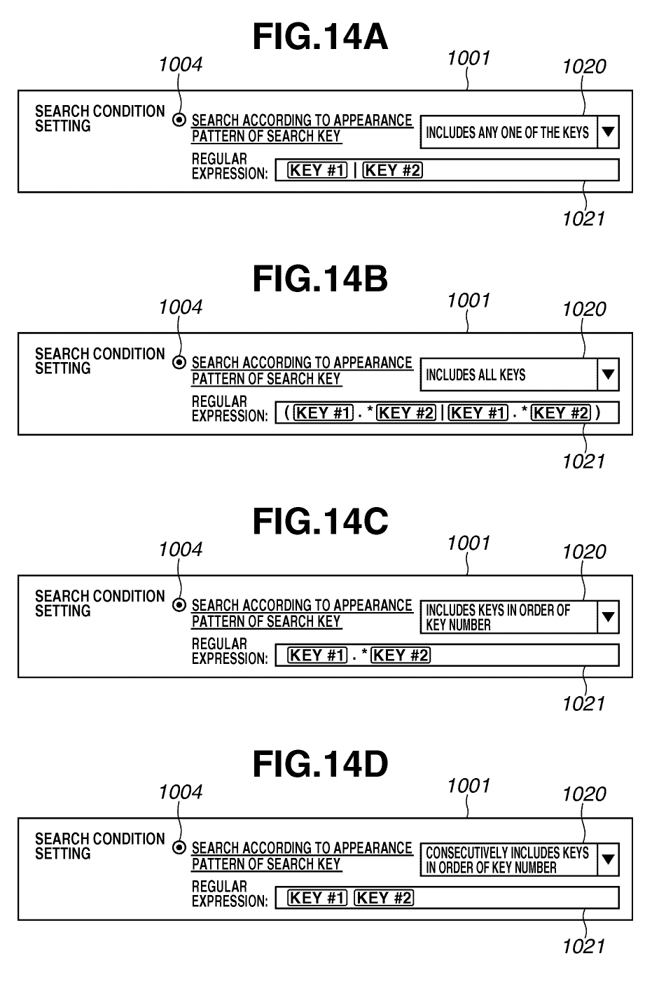

An example of an alternative selected in the search key appearance pattern pull down menu 1020, namely, “includes any one of the keys in first half of document” indicates that a document including a page that hits any of the set search keys in a first half of the document is to be searched. Other alternatives in the search key appearance pattern pull down menu 1020 will be described below with reference to FIGS. 14A through 17.

A regular expression field 1021 becomes operative when the “search according to appearance pattern of search key” radio button 1004 is selected. The regular expression field 1021 indicates a pattern of appearance of the search key set as the search condition in the document.

When the search key appearance pattern pull down menu 1020 is selected by the user, a regular expression corresponding to a search condition (search key) is displayed. For a method of expressing a search key appearance pattern, a publicly known and widely used regular expression such as those used in a Perl language and a grep command can be utilized.

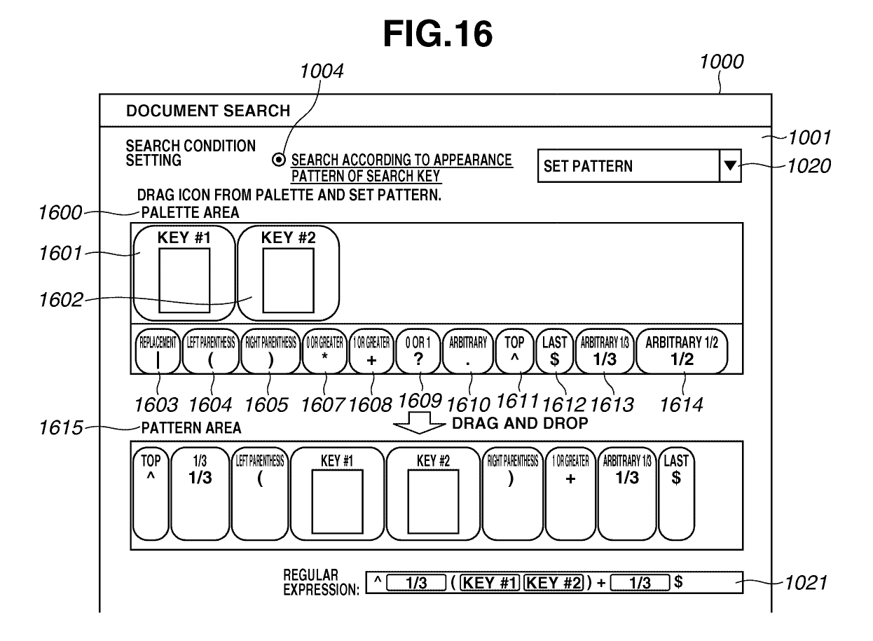

In the present exemplary embodiment, the regular expression is obtained by uniquely expanding a subset of the Perl language format. The regular expression field 1021 will be described in more detail below with reference to FIG. 16.

An “advanced search” radio button 1005 can be used by the user to search a document matching the search result according to a more detailed search condition set via a search option button 1022.

The search option button 1022 can be operated by the user to open a window for setting a detailed search condition. The setting of a detailed search condition include a setting of an advanced search condition used as a reference for determining a document that matches the search condition in the case where a search is performed in an advanced search mode. As an option for the detailed search, a condition using a meta data search or a full text search can be set along with the similar image search.

A meta data search is a search method in which a search condition can be designated per document meta data, per page record 805 or per data item stored on the corresponding job record 808, with respect to the document record 801 corresponding to the document. With the meta data search, the user can designate a search condition according to the tag, the document name, the document owner, the date and time of document creation, the data format, the number of pages, and the related documents.

Furthermore, the user can designate a search condition according to the job history and the page structure information. The job history includes the date and time, the operator, the job requesting apparatus, the job processing apparatus, the processed content, and other documents processed in the job.

Accordingly, with the meta data search, a document can be searched according to the related document information and the history of search of the document, in addition to the general search performed according to the document name, document owner, the date and time of creation, and the tag.

With the meta data search, a search can be performed according to whether a page constituting a document is oriented in a portrait orientation (in a lengthwise direction) or a landscape orientation (in a widthwise direction).

Furthermore, with the meta data search, a search can be performed according to a paper size, a page number from n to less than m, color/monochrome, a ratio of image and text. Moreover, with the meta data search, a search can be performed according to information related to a job such as who performed what job on the document with which apparatus and when.

A full text search is a searching method for a document in all the texts which includes a text string previously set as a search key. The text in a document refers to a text of the page content data included in the document content data 803 and the page record 804 within the document record 801.

Text data included in the document meta data 802 and the page record 805 can be added to the target of a full text search. The search condition can also be set such that the text data included in the job record 808 related to the document is added to the target of the full text search so that the document record 801 can be hit in the case when the job record 808 is hit.

Via a search key image input field 1002, the user can set and verify an image to be designated as a search key for a similar image search.

A document image scan button 1006 can be operated by the user to enter an image of a document obtained by reading a paper document with the scanner 113 of the image processing apparatus 110, as a search key for a similar image search. When the user presses the document image scan button 1006, the CPU 301 opens an image scan window. Via the image scan window, the user can set a parameter for reading an image of a document, as well as a setting for reading a document for the copy function 704 and the send function 705 of the image processing apparatus 110 or a setting for reading a document for a general scanner device driver based on TWAIN.

When the user presses the start key 505, the CPU 301 scans the document image according to the designated document image reading parameters and inputs the read image data as a search key image. If the image scan window is active at the time the scanning of the document image is completed, the CPU 301 closes the window.

When the user presses the start key 505 instead of the document image scan button 1006, the scanner 113 scans the document image according to default document reading parameters or the document reading parameters set so far.

A box image selection button 1007 can be operated by the user to select a search key image from among the previously stored documents utilizing the box function 706 of the image processing apparatus 110. With the box function 706, the user can browse the documents stored on the HDD 304 of the image processing apparatus 110 to select a document including an image desired to be used as a search key image.

Furthermore, with the box function 706, the user can access an HDD of the image processing apparatus 120 or the image processing apparatus 130 or the shared file system allowed to be shared by the PC 101 or the PC 102 via the LAN 100 to browse the stored documents and select a document including an image that the user desires to use as a search key image.

Moreover, with the box function 706, the user can access the shared file system or the database system provided by the server system 140 via the LAN 100 to browse the stored document files and select a document including an image that the user desires to use as a search key image.

Via a search key image setting field 1008, the user can verify and operate the combination of set search key image.

A search key image setting status message 1009 describes a status of the set search key images. More specifically, the search key image setting status message 1009 indicates the number of set search key images.

A search key image display field 1010 displays the set search key images. The search key image display field 1010 displays in order a combination of search key icons corresponding to the set search key images. When the user enters a search key image via the document image scan button 1006 or the box image selection button 1007, a corresponding search key icon is added to the search key image display field 1010.

A search key icon 1011 corresponds to one search key image. The user can instruct various operations to the search key via the search key icon 1011.

A search key ID 1012 is identification information (an identifier) for identifying the search key.

A search key thumbnail 1013 is a thumbnail image for the search key. When the user presses the search key thumbnail 1013, an image viewer window is opened and the search key image having a size larger than the search key thumbnail 1013 is displayed. The user can check the search key image in more detail via the image viewer window.

Search key outline information 1014 shortly describes the search key image.

A search key details button 1015 can be operated by the user to check detailed information about the search key image. The user can open a search key details window for displaying information about the search key which is more detailed than the search key outline information 1014.

The user can set a search condition unique to the search key image via the search key details window. The user can store the search key image in a box to use the search key again in a subsequent search.

A search key edit button 1016 can be operated by the user to open a search key edit window for editing the search key image.

Via the search key edit window, the user can perform various image processing, such as trimming, masking, or noise reduction, on the search key image, to obtain a desired search key image. Furthermore, the user can divide the search key image into a plurality of search key images. In addition, the user can divide one search key corresponding to the document including a plurality of page images in the unit of one page image, into a plurality of search key images each corresponding to each page image.

A search key delete button 1017 can be operated by the user to delete the search key image from the combination of search keys. The user can operate a search start instruction field 1003 to start the search processing.

A search start button 1018 can be operated by the user to start search processing. When the user presses the search start button 1018, the CPU 301 issues a request for starting search processing to the job archiving application of the server system 140 using the search condition designated via the search condition setting field 1001 and the search key image entered via the search key image input field 1002.

FIG. 11 illustrates an example of a document search result list screen of the document search application according to the present exemplary embodiment. Referring to FIG. 11, a document search result list screen 1100 is an example of a screen that displays a result of the search when the document search application has received a response to the search processing request from the job archiving application.

The document search application according to the present exemplary embodiment displays the document search result list screen in the display field 702 of the operation unit 112. The document search result list screen 1100 includes a search list operation field 1101, a search list display field 1102, and a scroll bar 1103.

Via the search list operation field 1101, the user can perform an operation and settings for controlling the display state of the search result list. A display-filtering display 1104 indicates by which display filter the documents displayed in the search list display field 1102 have been screened and extracted from a plurality of documents hit as a result of searching. In FIG. 11, a state “all documents” indicates that all documents hit as a result of the search is shown.

The display-filtering display 1104 can display all the hit documents received from the retrieval unit 212 of the server system 140 (namely, without using a filter). Furthermore, the display-filtering display 1104 can display documents extracted according to a setting of the display filter to narrow the displayed documents out of all the hit documents.

A display filter setting button (filter) 1105 can be operated by the user to set a condition for the display filter. When the user presses the display filter setting button 1105, the CPU 301 opens a display filter setting window. The user can set a desired filtering condition via the display filter setting window. The user can set a filter condition based on various information included in the document records 801 of the hit documents.

More specifically, the user can set a condition as a pattern matching for each information described or stored in the document meta data 802, the page meta data 805 of the page record 804 of the hit page, or the job record 808 associated with the document. In other words, the user can set a filtering condition similar to the detailed search option that can be set via the search option button 1022.

For example, the user can perform filtering according to a related document or a search history of the document, in addition to general filtering according to the document name, the date and time of document creation, or the tag added to the document. The user can further use a search condition as the search key and the similarity to the document data, as a display filter setting condition for narrowing the search.

In addition, the user can perform a filtering according to whether a page constituting the document is oriented in a portrait (lengthwise) orientation or a landscape (widthwise) orientation. Furthermore, the user can perform filtering according to a paper size, a page number from n to less than m, whether the document is a color document or a gray-scale document (a document having a continuous tone image), whether the document has a monochromatic binary image, and a ratio of images and documents. Moreover, the user can perform filtering according to information related to the job as to who performed what job on the document with which apparatus and when.

According to an embodiment, not only the search list display field 1102 can display all the documents hit in the search, but also the user can set a filter for extracting and displaying a list of documents that satisfy a specific condition. In addition, according to an embodiment, the search result list is updated immediately after a setting is changed. Thus, the user can easily find a desired document from among a large number of candidate documents.

Via a display attribute setting field 1106, the user can perform a setting for controlling items to be displayed per each document in displaying the combination of documents hit by the search in the search list display field 1102. Each time the user presses a rectangular portion of the check box or a labeled text string added to the check box, the state of the check box is alternatively switched between a selected state and a non-selected state.

When a “display attribute information” check box is selected, the CPU 301 displays meta data related to the document on the search list display field 1102, such as the document name, the data format, the number of pages, and the document location information. When a “display thumbnail” check box is selected, the search list display field 1102 displays thumbnail images of the pages hit by the search according to the search condition.

Via a display document summary thumbnail setting field 1107, the user can perform a setting for controlling a display format of a document summary thumbnail displayed per document, in displaying the documents hit by the search in the search list display field 1102.

When the “display thumbnail” check box in the display attribute information 1106 is selected and a “display document summary thumbnail” check box is also selected, a document summary thumbnail is displayed. The “document summary thumbnail” refers to a combination of thumbnails corresponding to the pages constituting the document displayed in order, so that the outline of the document can be visually and easily recognized by the user.

Via a document summary thumbnail configuration setting field 1108, the user can set a configuration of the thumbnails constituting the document summary thumbnail. The document summary thumbnail configuration setting field 1108 includes four text entry fields for entering numerical values. The four fields are respectively provided with a label text string of “top”, “previous”, “subsequent”, and “last”.

The user can enter a numerical value for the “top” field to perform a setting as to the number of pages from the top page of the document, for which the thumbnails are to be displayed. The user can enter a numerical value for the “previous” field to perform a setting as to the number of pages previous to the pages hit by the search, for which the thumbnails are to be displayed. The user can enter a numerical value for the “subsequent” field to perform a setting as to the number of pages subsequent to the pages hit by the search, for which the thumbnails are to be displayed. The user can enter a numerical value for the “last” field to perform a setting as to the number of pages from the last page of the document, for which the thumbnails are to be displayed.

A “display animation” check box 1109 can be operated by the user to perform a setting for displaying the document summary thumbnail with animation.

A re-search button 1110 can be operated by the user to return to the document search screen 1000.

A search refining button 1111 can be operated by the user to return to the document search screen 1000 to perform a narrow search. In this case, the user presses the search refining button 1111 after checking a document to be added to the search key (namely, a document including an image to be added to the search key) from among the documents displayed in the search list display field 1102.

When the user presses the search refining button 1111, the screen returns to the document search screen 1000 in a state where the checked document is added to the search key image display field 1010 as a search key, and thus the user can continue a narrow search.

By adding as many proper search key images as possible with a simple operation, the search hit ratio of a desired document (ratio of cases where documents match the set condition) can be increased, and thus the user can more easily find a desired document.

Furthermore, by analyzing a feature amount in the added search key image and adjusting a mark allocation for various feature amounts in determining the degree of similarity, a similar image search more appropriate to the desire of the user can be performed.

That is, the search key image added by the user to narrow the search can be determined to be a sample image, whose degree of similarity to the search key image is subjectively higher from the viewpoint of the user instructing the search. Accordingly, the point allocation for combining a plurality of feature amounts and a similarity determination algorithm can be adjusted so as to raise the similarity of the search key image evaluated during the search processing.

For example, in the case where the similarity determined according to the shape of the images is higher and the similarity determined according to the tone of the images between an original search key image and the added search key image is lower, the search can be performed by giving higher priority to the similarity determined according to the image shape than the similarity determined according to the tone of the images, in a narrow search. In a similar manner, the search can be properly performed by giving priority to the tone, the color patterns of the image or the degree of similarity of the object tree structure.

The search list display field 1102 displays a list of documents that have satisfied the search condition as a result of a search. Search hit document display fields 1112, 1113, 1114, and 1115 each display information corresponding to the document that has matched the search condition in a narrow search.

In a default setting, the documents that has a higher hit ratio (degree of satisfaction of the set conditions) are listed higher above the other documents. If a plurality of documents has the same hit ratio, a document having a higher document rank, which is determined by evaluating a significance of the document in a numerical value, is displayed higher above the other document in the list.

The user can press the display filter setting button 1105 to rearrange the documents in the list by an order other than the default order to display the documents in the newly set order.

For example, the documents can be displayed in an ascending or descending order according to various meta data associated with the document, such as the date of document creation, a last reference date, the document name, the data format, the number of pages, the document location, the operated apparatus, or the date and time and the content of the job performed on the document. The display of the list is immediately updated after the display order of the documents in the list is changed.

Now, the document hit ratio, which is one of the references for the order for displaying the documents in a default setting, will be briefly described below. A similar image search is performed according to a degree of similarity uniquely determined per each algorithm.

In general, a “similarity” is a continuous quantity for expressing a “degree of similarity”, and does not binarily express “presence or absence of similarity”. In the present exemplary embodiment, an image having a similarity lower than a predetermined threshold value is determined to have no similarity.

Images having a similarity higher than a predetermined threshold value can be classified into an image having a relatively high similarity and an image having a relatively low similarity.

A hit ratio is calculated according to a result of determination as to the similarity between the search key image included in the designated search condition and the image included in the searched document data. That is, the calculated hit ratio is higher for a document including an image having a relatively high similarity than a document including an image having a relatively low similarity.

In addition, a plurality of search keys can be designated by the user. Accordingly, a document that satisfies a greater number of search conditions can have a higher hit ratio than a document that satisfies a smaller number of search conditions. In the case where a plurality of search key images are designated by the user for a similar image search, the hit ratio of a document that has a larger number of images of relatively high similarity is set higher.

When the user presses an “includes all keys” radio button and starts a search, no document can be hit unless a document matches all the designated search keys.

Now, a document rank, which is a reference for determining an order to display documents in a default setting, will be described below. A document rank is calculated as an indicator for expressing a significance of the document. The document rank is determined according to a significance degree explicitly allocated to a document as meta data for the document.

Furthermore, the document rank is calculated also according to the attributes of the document such as a degree of confidentiality, the document owner, the person who created the document, the storage location, and the number of pages. In addition, the document rank can be calculated according to the number and type of tags added after the document was created, the number of times of reference, and the network for referring to related documents.

The “document rank according to the network for referring to the related documents” can be calculated in such a manner that a document that has been often referred to by a document having a high document rank, has a relatively high document rank. In addition, a document having a history of having been processed together with a high-rank document (that is, if a document is processed at the same time as a high-rank document is printed, sent, stored, retrieved, or subjected to a combined job) is given a relatively high document rank.

With respect to documents listed in a relatively low order which are displayed in the search list display field 1102, the total number of documents displayed in one screen can be increased, by simplifying the display of search-hit documents or reducing the size of the search-hit documents than documents listed in a relatively high order in the search list display field 1102.

According to the present exemplary embodiment, in a default setting, the documents can be listed in an order of hit ratio, document rank, meta data associated with the document, or meta data for the job performed on the document. Further, the display of the list is immediately updated after the order of display of the documents in the list is changed. Accordingly, the user can easily find a desired document from among a large number of candidate documents.

The scroll bar 1103 can be operated by the user to scroll up or down the document search result list screen 1100. In certain cases, the search list display field 1102 may display a large number of documents. In such cases, all the documents cannot be fully displayed in the display area of the touch panel 502 of the operation unit 112. The user can scroll the document search result list screen 1100 to browse the document list and search for a desired document from among the listed documents. Each of the documents listed as a search result can be divided into a plurality of pages to be displayed in the search result list. In this case, a button (not illustrated) is provided for shifting to a subsequent or previous page in a lowermost portion of the search list display field 1102.

Furthermore, the apparatus can be configured such that when the user presses a list print button (not illustrated) provided in a lower portion of the search list display field 1102, the document search result list is printed out.

It is difficult to satisfy mutually conflicting demands at the same time, namely, a demand for browsing as many documents as possible in a display area having a limited size to select a desired document and a demand for visually comparing document summary thumbnails having as detailed a content as possible.

However, according to the present exemplary embodiment, the document search result can be printed out immediately after it is displayed. Accordingly, the user can easily find a desired document by printing out the document search result list on an output paper having a resolution higher than the touch panel 502 and thus having a higher browsability.

The search hit document display fields 1112, 1113, 1114, and 1115 (FIG. 11) have a mutually similar configuration. In each of the search hit document display fields 1112, 1113, 1114, and 1115, a text string indicated in italic characters shows that an actual value for the corresponding meta data included in the document is displayed on the screen. Furthermore, with respect to an underlined text string, when the user presses the display area of the underlined text string, a detailed information display window opens so that the user can check more detailed information as to each information.

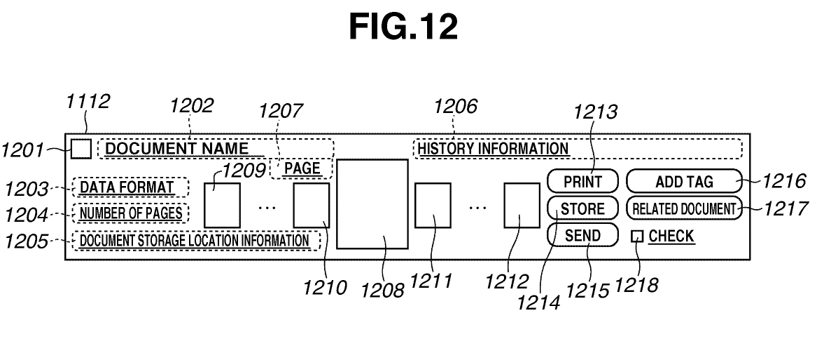

FIG. 12 illustrates an example of the search hit document display field 1112 as an example according to the present exemplary embodiment.

Referring to FIG. 12, a data format icon 1201 describes a data format of a corresponding document. A document name 1202 is a text string that describes a document name of a corresponding document. A data format 1203 describes a data format of a corresponding document. A number of pages 1204 describes a number of pages of a corresponding document.

Document storage location information 1205 is a text string used for identifying a storage position (location) in a file server that stores a corresponding document. The document storage location information 1205 can be identified using a uniform resource identifier (URI) or a file path text string in the file system or the file server.

In the case of a document stored by the job archiving system, a location can be displayed at which the duplicate data of the target document acquired in a job by the job archiving system, is stored. Alternatively, if a location at which original data of the target document can be identified, the identified location of the original data can be displayed.

History information 1206 is a text string that describes a history as to previously performed job processing or search processing on a corresponding document Using the history information 1206, the user can check history information as to who performed what processing on a specific document with which apparatus and when.

A page 1207 is a text string that indicates a page number of a corresponding document hit by the search with the search key.

A hit page thumbnail 1208 is a thumbnail image that displays an outline of an image component or a page of a corresponding document hit by a search according to the condition determined with the search key.

A top page thumbnail 1209 is a thumbnail image displaying an outline of a top page of a document corresponding to the top page thumbnail 1209. Thumbnail images corresponding to the number of pages are displayed as a list which are set by the user via the document summary thumbnail configuration setting field 1108.

A previous page thumbnail 1210 is a thumbnail image displaying an outline of a page previous to the page hit by the search using the search key. Thumbnail images corresponding to the number of pages are displayed as a list which are set by the user via the document summary thumbnail configuration setting field 1108.

A subsequent page thumbnail 1211 is a thumbnail image displaying an outline of a page subsequent to the page hit by the search with the search key. Thumbnail images corresponding to the number of pages are displayed as a list which are set by the user via the document summary thumbnail configuration setting field 1108.

A last page thumbnail 1212 is a thumbnail image displaying an outline of a last page of a document corresponding to the last page thumbnail 1212. Thumbnail images corresponding to the number of pages are displayed as a list which are set by the user via the document summary thumbnail configuration setting field 1108.

As described above, it is difficult to satisfy mutually conflicting demands, namely, a demand for browsing as many documents as possible at the same time in a display area having a limited size to select a desired document and a demand for visually comparing document summary thumbnails having as detailed a content as possible.

However, according to the present exemplary embodiment, the page configuration displayed in a document summary thumbnail and the number of pages can be easily changed. Accordingly, the user can easily find a desired document by a simple operation.

When a considerably large number of pages is displayed by the document summary thumbnail, it can be configured such that the search results can be adjusted to display smaller thumbnails at a high reduction ratio so that all the thumbnails can be displayed in the display area having a limited size.

Alternatively, the display can be controlled so that thumbnails of the pages having a relatively low priority can be displayed at a high reduction ratio, or a part of a page is displayed in a manner superposing on and hiding behind a previous page. Further alternatively, the display of the search results can be limited to adjust the display of the search result so that the display of the search results can be fully displayed in the display area having a limited size.

If the size of the display area is too small to sufficiently display search results, the following algorithms can be used to select a high-priority page which is displayed in the document summary thumbnail. That is, for example, an algorithm for giving priority to pages at the top of the document, an algorithm for giving priority to a page hit by a previously-designated search key, and an algorithm for giving priority to a page having a higher similarity when hit by the condition for a similar image search, can be used.

A print button 1213 can be operated by the user to print out a corresponding document using a print function of the image processing apparatus 110. A store button 1214 can be operated by the user to store the corresponding document by the box function 706 of the image processing apparatus 110. A send button 1215 can be operated by the user to send the corresponding document by the send function 705 of the image processing apparatus 110.

A tag adding button 1216 can be operated by the user to operate a tag of the corresponding document. When the user presses the tag adding button 1216, a document tag window opens. The user can newly add and resister an arbitrary tag as well as browse and edit the tag already set to the document.

A related document button 1217 can be operated by the user to perform a setting for operating a document associated with the corresponding document (related document). When the user presses the related document button 1217, a related document window opens and the user can browse and edit the related document associated with the corresponding document. Furthermore, the user can associate another document with the corresponding document and add and register the associated document as a related document via the related document window.

A check box 1218 can be operated by the user to check a corresponding document. When an operation is selectively performed on a plurality of documents listed in the display field, the user can select a plurality of documents from among the documents whose check box 1218 has been checked. For example, when the user presses the search refining button 1111 after checking the check box 1218, the checked (selected) documents are added to the search key, and a narrow search is performed in this state.

According to the present exemplary embodiment, with the document summary thumbnail described above, the user can visually recognize pages before and after the hit page, and an outline of the document at a glance, in addition to the pages hit by the search. Thus, the user can easily find a desired document from among the search result list.

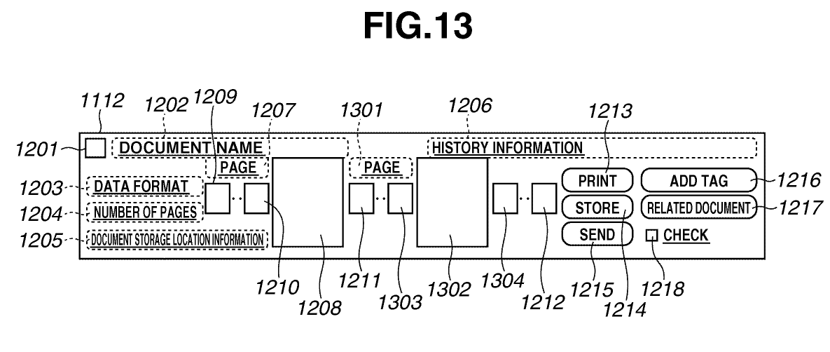

FIG. 13 illustrates an example of the search hit display of a document whose plurality of pages has been hit by the search according to the present exemplary embodiment. Display items similar to those described above are provided with the same numerals and symbols and a description thereof is not repeated.

A similar image search is performed based on a continuous degree of similarity. Accordingly, a plurality of similar images included in one document can be hit by the search. Furthermore, in a similar image search according to the present exemplary embodiment, the user can perform a search with a plurality of designated search keys and search conditions. Accordingly, a plurality of pages in one document can be hit by the search. FIG. 13 illustrates an example of display of documents whose two hit page thumbnails 1208 and 1302 have been hit by the search, according to the present exemplary embodiment.

Referring to FIG. 13, a page 1301 is a text string indicating a page number that is secondly hit by the search according to the condition with the search key, of pages constituting the corresponding document. The hit page thumbnail 1302 is a thumbnail image indicating an outline of the page that is secondly hit by the search with the search key, of the pages constituting the corresponding document.

A previous page thumbnail 1303 is a thumbnail image indicating an outline of a page previous to the page secondly hit by the search with the search key. Thumbnail images corresponding to the number of pages set by the user via the document summary thumbnail configuration setting field 1108 are displayed as a list.

A subsequent page thumbnail 1304 is a thumbnail image indicating an outline of a page subsequent to the page secondly hit by the search with the search key. Thumbnail images corresponding to the number of pages set by the user via the document summary thumbnail configuration setting field 1108 are displayed as a list.

It is difficult to satisfy mutually conflicting demands at the same time, namely, a demand for browsing as many documents as possible in a display area having a limited size to select a desired document and a demand for visually comparing document summary thumbnails having as detailed a content as possible.

However, according to the present exemplary embodiment, the configuration of the page displayed in a document summary thumbnail and the number of pages therefor can be easily changed. Accordingly, the user can easily find a desired document by a simple operation.

In the case of the display illustrated in FIG. 13, as in the case of the example in FIG. 12, it can be configured such that the search results can be adjusted to display smaller thumbnails at a high reduction ratio so that all the thumbnails can be displayed in the display area having a limited size.

Alternatively, the display can be controlled so that thumbnails for the pages having a relatively low priority can be displayed at a high reduction ratio or a part of a page is displayed in a manner superposing on and hiding behind a previous page.

Further alternatively, the display of the search results can be limited to adjust the display of the search result so that the display of the search results can be fully displayed in the display area having a limited size.

If the size of the display area is too small to sufficiently display search results, a priority degree can be set on a document summary thumbnail image, to adjust the display of the search results. The following algorithms can be used to select a high-priority page displayed in the document summary thumbnail.

That is, for example, an algorithm for giving priority to pages at the top of the document, an algorithm for giving priority to a page hit by a previously-designated search key, and an algorithm for giving priority to a page having a higher similarity when hit by the condition for a similar image search, can be used.

FIGS. 14A through 14D each illustrate an example of a screen for setting a search condition determined according to an appearance pattern of a search key image according to the first exemplary embodiment of the present invention.

In the search condition setting field 1001 of the document search screen 1000 (FIG. 10), a setting illustrated in each of FIGS. 14A through 14D can be performed on the search key appearance pattern pull down menu 1020 and the regular expression field 1021.

FIG. 14A illustrates an example in which a search condition is set according to an appearance pattern of a search key “includes any one of the keys”. When the search condition “includes any one of the keys” has been set, a document including an image similar to any one of the designated search key images at any position thereof is searched for.

FIG. 14B illustrates an example in which a search condition is set according to an appearance pattern of a search key “includes all keys”. When the search condition “includes all keys” has been set, a document including images similar to all the designated search key images at any position thereof is searched for.

FIG. 14C illustrates an example in which a search condition is set according to an appearance pattern of a search key “includes keys in order of key number”. When the search condition “includes keys in order of key number” has been set, a document including images similar to all the designated search key images at any position thereof in an order designated by the search key, is searched for—A document in which an arbitrary image is included between images hit by each search key, can satisfy the search condition in FIG. 14C.

FIG. 14D illustrates an example in which a search condition according to an appearance pattern of a search key “consecutively includes keys in order of key number” is set. When the search condition “consecutively includes keys in order of key number” has been set, a document consecutively including images similar to all the designated search key images at any position thereof in an order designated by the search key, is searched for. A document in which another arbitrary image is included between images hit by each search key does not satisfy the search condition in FIG. 14D.

A search condition under which a document that does not satisfy either of the search conditions in FIGS. 14A through 14D (negative condition) can be additionally set as an optional setting item (not illustrated). Furthermore, a search condition “negative to key image”, under which an image that has an extremely low similarity with the search key image and is not hit by the search with the search key image, is detected, can be included in the search condition.

According to the present exemplary embodiment, in a document search according to an image search, a user can perform the document search with a search condition designated according to an appearance pattern of a search key image in a document.

Furthermore, according to the present exemplary embodiment, in a document search according to an image search, a user can perform the document search according to an image search with which only a document substantially similar to a desired document can be hit, by setting a detailed search condition to carry out a narrow search.

In addition, according to the present exemplary embodiment, a partial matching search for an image constituting a document can be performed.

Moreover, according to the present exemplary embodiment, the user can perform a practical search using an intuitive search condition such as “search for a document whose first several pages are similar (e.g., search a plurality of versions of the document from a draft to a final version)”.

### Second Exemplary Embodiment

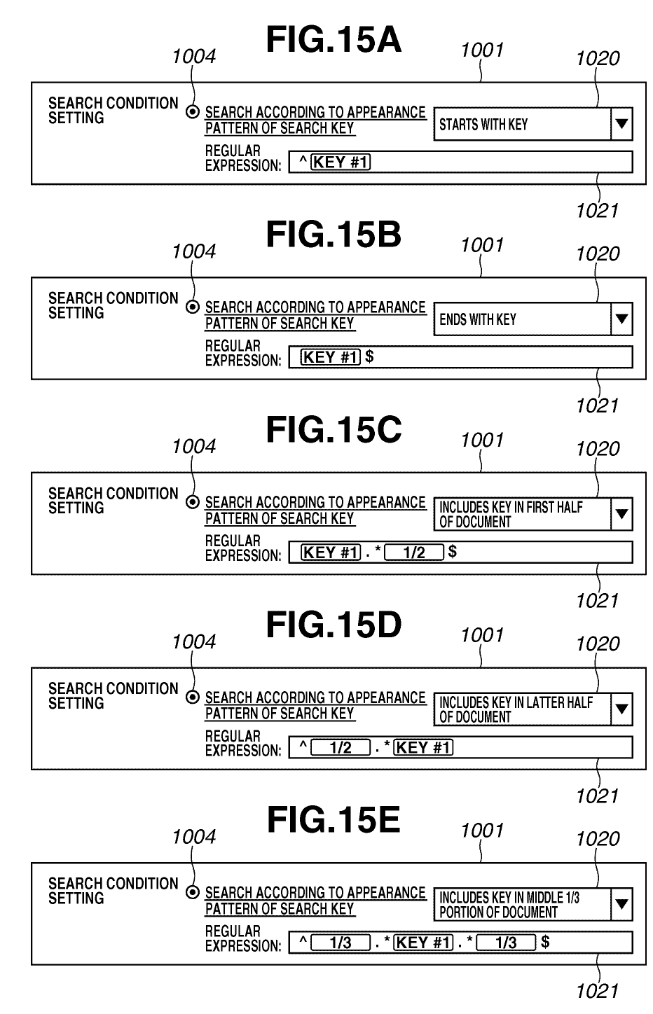

FIGS. 15A through 15E each illustrate an example of a screen for setting a search condition determined based on an appearance pattern of a search key image according to a second exemplary embodiment of the present invention.

In the search condition setting field 1001 of the document search screen 1000 (FIG. 10), a setting illustrated in each of FIGS. 15A through 15E can be performed on the search key appearance pattern pull down menu 1020 and the regular expression field 1021.

FIG. 15A illustrates an example in which a search condition is set according to an appearance pattern of a search key “starts with key”. When the search condition “starts with key” has been set, a document including an image similar to the designated search key images at a top of the document is searched for.

FIG. 15B illustrates an example in which a search condition is set according to an appearance pattern of a search key “ends with key”. When the search condition “ends with key” has been set, a document including an image similar to the designated search key images at a last portion of the document is searched for.

FIG. 15C illustrates an example in which a search condition is set according to an appearance pattern of a search key “includes key in first half of document”. When the search condition “includes key in first half of document” has been set, a document including an image similar to the designated search key images in a first half of the document is searched for. That is, a search is performed as to whether any of the pages in the first half of the document includes the search key image.

FIG. 15D illustrates an example in which a search condition is set according to an appearance pattern of a search key “includes key in latter half of document”. When the search condition “includes key in latter half of document” has been set, a document including an image similar to the designated search key images in a latter half of the document is searched for. That is, a search is performed as to whether any of the pages in the latter half of the document includes the search key image.

FIG. 15E illustrates an example in which a search condition is set according to an appearance pattern of a search key “includes key in middle ⅓ portion of document”. When the search condition “includes key in middle ⅓ portion of document” has been set, a document including an image similar to the designated search key images in a middle of the three-way split document is searched for. That is, a search is performed as to whether any of the pages in a middle ⅓ portion of the document includes the search key image.

A search condition under which a document that does not satisfy either of the search conditions in FIGS. 15A through 15E (negative condition) can be additionally set as an optional setting item (not illustrated). Furthermore, a search condition “negative to key image”, under which an image that has an extremely low similarity with the search key image and is not hit by the search with the search key image is detected, can be included in the search condition.

According to the present exemplary embodiment, in a document search according to an image search, a user can perform the document search with a search condition designated according to an appearance pattern of a search key image in a document.

Furthermore, according to the present exemplary embodiment, in a document search according to an image search, a user can perform the document search according to an image search with which only a document substantially similar to a desired document can be hit, by setting a detailed search condition to carry out a narrow search.

Moreover, according to the present exemplary embodiment, the user can perform a practical search using an intuitive search condition such as “search for a document whose first several pages are similar (e.g., search a plurality of versions of the document from a draft to a final version)”.

### Third Exemplary Embodiment

FIG. 16 illustrates an example of a screen for setting a search condition determined based on an appearance pattern of a search key image according to a third exemplary embodiment of the present invention.

Via the search condition setting field 1001 of the document search screen 1000 (FIG. 10), the user selects an item “set pattern” in the search key appearance pattern pull down menu 1020. When the user selects the item “set pattern”, palette areas 1600 and 1615 are displayed. The user can perform a detailed setting for the pattern via a graphical user interface.

The palette area 1600 displays a combination of icons equivalent to components constituting a pattern. In the palette area 1600, key component icons 1601 and 1602 and regular expression component symbol icons 1603 and 1614 are displayed. The regular expression component symbol icons 1603 and 1614 each express a descriptive search condition for controlling a search with the designated key component icons (key images) 1601 and 1602.

The user selects an icon from the palette area 1600 and drag-and-drops the selected icon on the palette area 1615 to add a pattern constituent equivalent to the selected icon, to the setting set for the search condition.

A replacement symbol icon 1603 is a replacement operator icon operated by the user to designate an alternative constituted by two patterns. For example, in the case of “a|b”, the target document satisfies (matches) the search condition if the target document includes a pattern “a” or a pattern “b”.

A left parenthesis symbol icon 1604 and a right parenthesis symbol icon 1605 are icons for expressing grouping of patterns. By enclosing patterns with the left parenthesis symbol icon 1604 and the right parenthesis symbol icon 1605, the user can designate a subpattern used as one unit. For example, in the case of “a(b|c)d”, the target document satisfies (matches) the search condition if the target document includes a pattern “abd” or a pattern “acd”.

A “0 or greater” repetition symbol icon 1607 is an icon for expressing that the target document satisfies (matches) the search condition if the target document includes a repetition pattern repeating a previous component 0 or greater times. For example, in the case of using “ab*c”, the target document satisfies (matches) the search condition if the target document includes a pattern “a”, a pattern “b”, or a pattern “ab”, such as patterns “ac”, “abc”, “abbc”, “abbbc”, and so on.

A “1 or greater” repetition symbol icon 1608 expresses that the target document satisfies (matches) the search condition if the target document includes a repetition pattern repeating a previous component 1 or greater times. For example, in the case of “ab+c”, the target document satisfies (matches) the search condition if the target document includes patterns “abbc”, “abbbc”, and so on.

A “0 or 1” symbol icon 1609 expresses that the target document satisfies (matches) the search condition if the target document includes no repetition of a previous component or only a once-repeated pattern. For example, in the case of “ab?c”, the target document satisfies (matches) the search condition if the target document includes patterns “ac” and “abc”.

An arbitrary symbol icon 1610 expresses that the target document matches an arbitrary image. For example, in the case of “a.b”, the target document matches the search condition if the target document includes patterns “aab”, “abb”, “abb”, “acb”, “adb”, and so on. Furthermore, “.*” expresses a search condition for searching for a pattern in which an arbitrary image is repeatedly included in the target document in 0 or greater times.

A top symbol icon 1611 is a position designator that expresses a condition for designating a search position matching a top portion of the target document. For example, in the case of “̂a”, the target document satisfies (matches) the search condition if a pattern “a” exists at the top of the target document.

An end symbol icon 1612 is a position designator that expresses a condition for designating a search position matching an end portion of the target document. For example, in the case of “a$”, the target document satisfies (matches) the search condition if a pattern “a” exists at the end portion of the target document.

An arbitrary ⅓ document symbol icon 1613 is an icon for searching for a pattern that matches an arbitrary part of a document equivalent to a substantially ⅓ portion of the document.

An arbitrary ½ document symbol icon 1614 is an icon for searching for a pattern that matches an arbitrary part of a document equivalent to a substantially ½ portion of the document.

A pattern area 1615 is an area via which the user sets a pattern of a document to be searched for. The user can drag-and-drop an icon positioned on the pattern area 1615 to arrange the order of the icons. In addition, the user can drag-and-drop an icon on a portion outside the pattern area 1615 to delete a component corresponding to the dropped icon from the set patterns.

The regular expression field 1021 displays a pattern graphically set in the pattern area 1615 by a regular expression. The user can enter a text string in the regular expression field 1021 via an operation of a keyboard (not illustrated) or the operation unit 112.

A search condition under which a document that does not satisfy either of the search conditions in the present exemplary embodiment (negative condition) can be additionally set as an optional setting item (not illustrated). Furthermore, a search condition “negative to key image”, under which an image that has an extremely low similarity with the search key image and is not hit by the search with the search key image is detected, can be included in the search condition.

According to the present exemplary embodiment, in a document search according to an image search, a user can perform the document search with a search condition designated based on an appearance pattern of a search key image in a document.

Furthermore, according to the present exemplary embodiment, in a document search according to an image search, a user can perform the document search according to an image search with which only a document substantially similar to a desired document can be hit, by setting a detailed search condition to carry out a narrow search.

Moreover, according to the present exemplary embodiment, the user can perform a practical search using an intuitive search condition such as “search for a document whose first several pages are similar (e.g., search a plurality of versions of the document from a draft to a final version)”.

### Fourth Exemplary Embodiment

In the above-described first, second, and third exemplary embodiments, a search pattern is set in the unit of a page that constitutes a document. In a fourth exemplary embodiment of the present invention, an appearance pattern of images in a page which constitute a page of a document is used as the search condition.

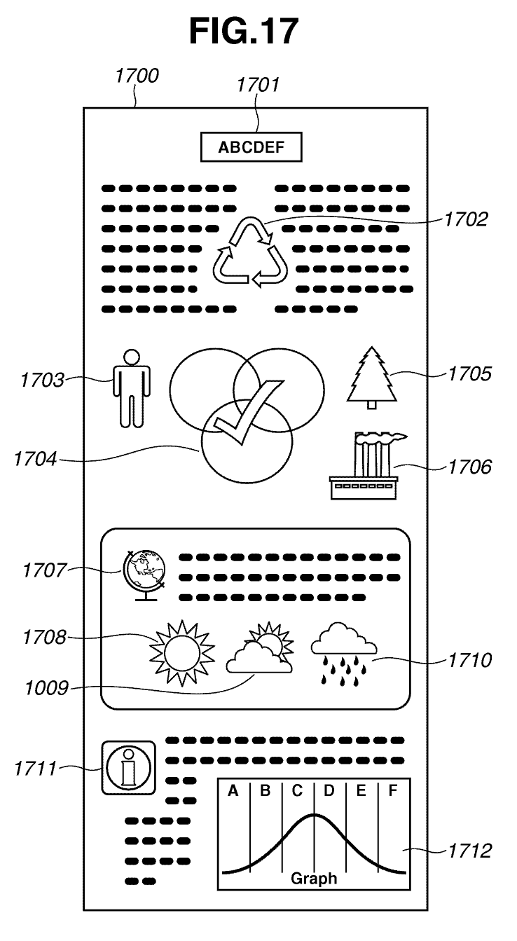

FIG. 17 illustrates an example of a document constituted by a plurality of image area components according to the present exemplary embodiment.

A document 1700 is an example of a document including a plurality of image areas and text areas. The document 1700 is analyzed by the image structure analysis unit 208 or the rasterization unit 210. As an analysis result, structure information as to pages can be obtained. According to the thus obtained structure information, components such as a plurality of images and a plurality of documents constituting the document can be divided into smaller units.

Furthermore, by analyzing a distance between the components and an arrangement or a practice for contextually arranging the components, which are determined based on each culture, a mutual relationship between the components can be obtained as structure information. If the target document is described by data coded according to Hypertext Markup Language (HTML), the data itself may describe the mutual relationship between the components.

The document 1700 includes image components 1701 through 1712. With respect to the image components 1701 through 1712, it can be analyzed that the image components 1701 through 1712 have a contextual relationship in an order of component number according to a cultural practice such that image components are first arranged in an order from left to right, then arranged in an order from top to bottom.

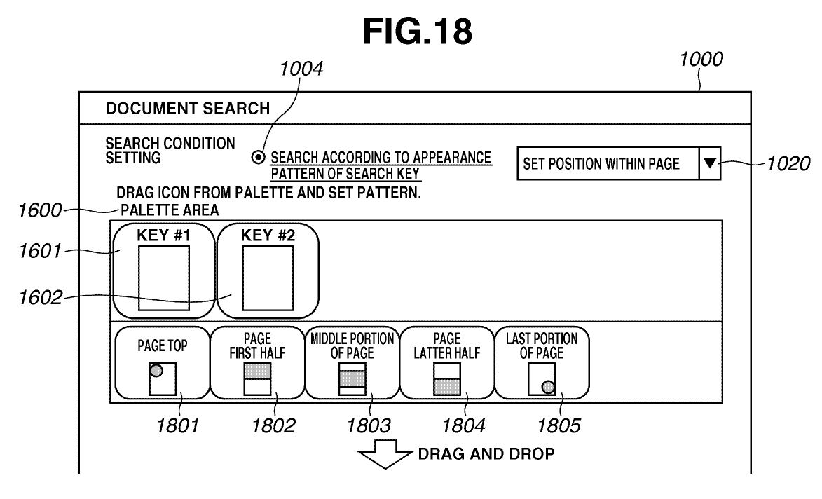

FIG. 18 illustrates an example of a screen for setting a search condition determined according to an appearance pattern of a search key image according to the fourth exemplary embodiment of the present invention.

Via the search condition setting field 1001 of the document search screen 1000 (FIG. 10), the user selects an item “set position within page” in the search key appearance pattern pull down menu 1020. When the user selects the item “set position within page”, palette areas 1600 and 1615 are displayed. The user can perform a detailed setting of the pattern via a graphical user interface.

The palette area 1600 displays a combination of icons equivalent to components constituting a pattern. In the palette area 1600, the key component icons 1601 and 1602 and regular expression component symbol icons 1801 through 1805 are displayed. The regular expression component symbol icons 1801 through 1805 each express a descriptive search condition for controlling a search with the designated key component icons (key images) 1601 and 1602.

The user selects an icon from the palette area 1600 and drag-and-drops the selected icon in the palette area 1615 to add a pattern constituent equivalent to the selected icon to the pattern setting.

A page top symbol icon 1801 expresses that the target page matches the search condition if a pattern that is a target of the search and positioned at an immediately previous position of the page, exists at atop position of the page that constitutes the document. For example, by placing the page top symbol icon 1801 at a position subsequent to the key component icon corresponding to the search key image, the user can search for a document including a page that has an image similar to the search key image at the top of the page.

A page first half symbol icon 1802 expresses that the target page matches the search condition if a pattern that is a target of the search and positioned at an immediately previous position of the page, exists in a first half of the page constituting the document. For example, by placing the page first half symbol icon 1802 at a position subsequent to the key component icon corresponding to the search key image, the user can search for a document including a page that has an image similar to the search key image in a first half of the page.

A page middle portion symbol icon 1803 expresses that the target page matches the search condition if a pattern that is a target of the search and positioned at an immediately previous position of the page, exists in a middle portion of the page constituting the document. For example, by placing the page middle portion symbol icon 1803 at a position subsequent to the key component icon corresponding to the search key image, the user can search for a document including a page that has an image similar to the search key image in a middle portion of the page.

A page latter half symbol icon 1804 expresses that the target page matches the search condition if a pattern that is a target of the search and positioned at an immediately previous position of the page, exists in a latter half of the page that constitutes the document. For example, by placing the page latter half symbol icon 1804 at a position subsequent to the key component icon corresponding to the search key image, the user can search for a document including a page that has an image similar to the search key image in a latter half of the page.

A page end symbol icon 1805 expresses that the target page matches the search condition if a pattern that is a target of the search and positioned at an immediately previous position of the page, exists at an end position of the page that constitutes the document. For example, by placing the page end symbol icon 1805 at a position subsequent to the key component icon corresponding to the search key image, the user can search for a document including a page that has an image similar to the search key image at the end of the page.

By combining the search according to the appearance pattern in each page described in the above-described first, second, and third exemplary embodiments, and the search according to the image area appearance pattern within a page according to the present exemplary embodiment, the user can set a more complicated and detailed pattern as the search condition.

A search condition under which a document that does not satisfy either of the search conditions in the present exemplary embodiment (negative condition) can be additionally set as an optional setting item (not illustrated). Furthermore, a search condition “negative to key image”, under which an image that has an extremely low similarity with the search key image and is not hit by the search with the search key image, is detected, can be included in the search condition.

According to the present exemplary embodiment, in a document search according to an image search, a user can perform the document search with a search condition designated according to an appearance pattern of a search key image in a document.

Furthermore, according to the present exemplary embodiment, in a document search according to an image search, a user can perform the document search according to an image search with which only a document substantially similar to a desired document only can be hit, by setting a detailed search condition to carry out a narrow search.

Moreover, according to the present exemplary embodiment, the user can perform a practical search using an intuitive search condition such as “search for a document whose first several pages are similar (e.g., search a plurality of versions of the document from a draft to a final version)”.

### Other Exemplary Embodiments

An embodiment of The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes an embodiment of the present invention.

Accordingly, the program implementing the functions of the embodiments can be configured in any form, such as object code, a program executed by an interpreter, and script data supplied to an operating system (OS).

As the storage medium for supplying such program code, a floppy disk, a hard disk, an optical disk, a magneto-optical disk (MO), a compact disk read only memory (CD-ROM), a compact disk recordable (CD-R), a compact disk rewritable (CD-RW), a magnetic tape, a nonvolatile memory card, a ROM, and a digital versatile disk (DVD) (DVD-read only memory (DVD-ROM), DVD-recordable (DVD-R), and DVD-rewritable (DVD-RW)), for example, can be used.

In this case, the program code itself, which is read from the storage medium, implements the function of the embodiments mentioned above, and accordingly, the storage medium storing the program code constitutes the present invention.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of an embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-336377 filed Dec. 13, 2006, which is hereby incorporated by reference herein in its entirety.

What is claimed is:

1. An apparatus configured to search for a document including a plurality of image components, the apparatus comprising:
a key image designation unit configured to designate a key image to be used as a search key for an image search;
a pattern setting unit configured to set a pattern of appearance in a document of the image component equivalent to the key image designated by the key image designation unit as a search condition; and
a document search unit configured to search for a document using the search condition set by the pattern setting unit.

2. The apparatus according to claim 1, wherein the pattern setting unit further sets a pattern of appearance of the image component in a document that is not equivalent to the key image as the search condition.

3. The apparatus according to claim 1, wherein the pattern setting unit sets a search condition including a descriptive condition for controlling a search with the key image designated by the key image designation unit.

4. The apparatus according to claim 3, wherein the descriptive condition for controlling the search with the key image includes a descriptive component that expresses an appearance position of the image component equivalent to the key image in the document.

5. The apparatus according to claim 4, wherein the appearance position of the image component equivalent to the key image in the document includes a condition such that the document includes an image equivalent to the key image in a first half of the document, that the document includes an image equivalent to the key image in a middle portion of the document, and that the document includes an image equivalent to the key image in a latter half of the document, or a negative condition that does not correspond to any of the conditions.

6. The apparatus according to claim 3, wherein the descriptive condition for controlling the search with the key image includes a condition designated according to an appearance order of the image components corresponding to the key image.

7. The apparatus according to claim 6, wherein the appearance order of the image components corresponding to the key image includes a search condition such that the document includes either one of images equivalent to a plurality of key images designated by the key image designation unit, that the document includes all images equivalent to the plurality of key images designated by the key image designation unit, that the document includes images equivalent to the plurality of key images designated by the key image designation unit in an order designated by the key image designation unit, and that the document consecutively includes images equivalent to the plurality of key images designated by the key image designation unit in an order designated by the key image designation unit, or a negative condition that does not correspond to any of the conditions.

8. The apparatus according to claim 1, wherein the plurality of image components included in the documents is a combination of pages constituting the document.

9. The apparatus according to claim 1, wherein the plurality of image components included in the documents is a combination of image components included in each of the pages constituting the document.

10. A method for searching for a document that includes a plurality of image components, the method comprising:
designating a key image to be used as a search key for an image search;
setting a pattern of appearance in a document of the image component equivalent to the designated key image, as a search condition; and
searching for a document using the set search condition.

11. The method according to claim 10, further comprising setting a pattern of appearance of the image component in a document that is not equivalent to the key image, as the search condition.

12. The method according to claim 10, further comprising setting a search condition including a descriptive condition for controlling a search with the designated key image.

13. The method according to claim 12, wherein the descriptive condition for controlling the search with the key image includes a descriptive component that expresses an appearance position of the image component equivalent to the key image in the document.

14. The method according to claim 13, wherein the appearance position of the image component equivalent to the key image in the document includes a condition such that the document includes an image equivalent to the key image in a first half of the document, that the document includes an image equivalent to the key image in a middle portion of the document, and that the document includes an image equivalent to the key image in a latter half of the document, or a negative condition that does not correspond to any of the conditions.

15. The method according to claim 12, wherein the descriptive condition for controlling the search with the key image includes a condition designated according to an appearance order of the image components corresponding to the key image.

16. The method according to claim 15, wherein the appearance order of the image components corresponding to the key image includes a search condition such that the document includes either one of images equivalent to a plurality of designated key images, that the document includes all images equivalent to the plurality of designated key images, that the document includes images equivalent to the plurality of designated key images in a designated order, and that the document consecutively includes images equivalent to the plurality of designated key images in a designated order, or a negative condition that does not correspond to any of the conditions.

17. The method according to claim 10, wherein the plurality of image components included in the documents is a combination of pages constituting the document.

18. The method according to claim 10, wherein the plurality of image components included in the documents is a combination of image components included in each of the pages constituting the document.

19. A computer-readable storage medium storing instructions which, when executed by an apparatus, causes the apparatus to perform operations comprising:
designating a key image to be used as a search key for an image search;
setting a pattern of appearance of the image component equivalent to the designated key image in a document, as a search condition; and
searching for a document using the set search condition.
